(19) United States
(12) Patent Application Publication
(10) Pub. No.: US 2026/0180968 A1
(43) Pub. Date: Jun. 25, 2026

(54) INFORMATION TRANSMISSION METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 19/126,860

(22) PCT Filed: Nov. 4, 2022
(86) PCT No.: PCT/CN2022/130091

§ 371 Date: May 2, 2025

(51) Int. Cl. H04L 9/40; H04L 41/0893; H04L 41/0894; H04L 67/02

(52) U.S. Cl. CPC H04L 63/08; H04L 41/0893; H04L 41/0894; H04L 63/0823; H04L 63/10; H04L 63/101; H04L 63/102; H04L 63/20; H04L 67/02

(57) ABSTRACT

Embodiments of the present invention relate to an information transmission method and apparatus, a communication device, and a storage medium. A user equipment (UE) sends UE configuration information to a first entity, wherein the UE configuration information is used for determining core network auxiliary information open to an application function (AF), and the core network auxiliary information is associated with the UE.

### CROSS REFERENCE TO RELATED APPLICATION

This application is a National Stage of International Application No. PCT/CN2022/130091, filed on Nov. 4, 2022, which is incorporated by reference herein in its entirety for all purposes.

### TECHNICAL FIELD

The present application relates to, but is not limited to, the field of wireless communication technology, and in particular to information transmission methods, apparatuses, a communication device and a storage medium.

### BACKGROUND

The core network of mobile communications (e.g., the 5G core network) can exposure different types of core network assistance information, such as traffic, packet delay, packet loss rate, network status changes, candidate federated learning (FL) members, geographic distribution information and the like, to application functions, thereby facilitating completion of artificial intelligence (AI)/machine intelligence (MI) operations.

In some cases, individual information in the core network assistance information would not be considered privacy-sensitive, but such information combined with other seemingly unrelated privacy data may expose the user's privacy.

### SUMMARY

In view of above, embodiments of the present disclosure provide information transmission methods, apparatuses, a communication device and a storage medium.

According to a first aspect of embodiments of the present disclosure, there is provided an information transmission method, which is performed by user equipment UE and includes:

sending UE configuration information to a first entity, where the UE configuration information is used to determine core network assistance information exposed to an application function AF, and the core network assistance information is associated with the UE.

In an embodiment, the method further includes: sending UE configuration update information to the first entity, where the UE configuration update information is used to update the UE configuration information.

In an embodiment, the UE configuration update information is used to prohibit the core network assistance information from being exposed to the AF.

In an embodiment, the UE configuration information is associated with identity information of the UE; and the UE configuration information is to be sent to a second entity by the first entity.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
artificial intelligence (AI)/machine learning (ML) operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

According to a second aspect of embodiments of the present disclosure, there is provided an information transmission method, which is performed by a first entity and includes:
receiving UE configuration information sent by user equipment UE, where the UE configuration information is used to determine core network assistance information exposed to an application function AF, and the core network assistance information is associated with the UE.

In an embodiment, the method further includes: receiving UE configuration update information sent by the UE, where the UE configuration update information is used to update the UE configuration information.

In an embodiment, the UE configuration update information is used to prohibit the core network assistance information from being exposed to the AF.

In an embodiment, the method further includes: sending to a second entity an update indication to update the UE configuration information, where the UE configuration information is associated with identity information of the UE.

In an embodiment, the method further includes: sending the UE configuration information to a second entity, where the UE configuration information is subscribed or requested by the second entity to the first entity.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

According to a third aspect of embodiments of the present application, there is provided an information transmission method, which is performed by a second entity and includes:
determining, based at least on access configuration information, whether to expose core network assistance information to an application function AF, where the core network assistance information is associated with user equipment UE.

In an embodiment, the method further includes:
receiving an assistance information request from the AF, where the assistance information request is used to request the core network assistance information from the second entity.

In an embodiment, the method further includes at least one of following:
determining UE configuration information based at least on identity information of the UE carried in the assistance information request, where the UE configuration information is associated with the identity information of the UE;
determining, according to a UE group identifier carried in the assistance information request, identity information of the UE associated with the UE group identifier, and determining UE configuration information based at least on the determined identity information of the UE.

In an embodiment, the access configuration information includes: UE configuration information and/or a local policy pre-stored in the second entity; and
the method further includes: receiving the UE configuration information sent by the first entity.

In an embodiment, the first entity includes at least one of following:
unified data management UDM;
unified data repository function UDR;
an operator-deployed AF or a trusted AF.

In an embodiment, the method further includes:
sending to the AF the core network assistance information exposed to the AF.

In an embodiment, sending to the AF the core network assistance information that allows the AF to access includes:
sending to the AF the core network assistance information exposed to the AF in a security protection manner, where the security protection manner is indicated by the access configuration information.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes user consent information, and the user consent information is used to indicate that a user of the UE agrees to expose the core network assistance information to the AF.

According to a fourth aspect of embodiments of the present disclosure, there is provided an information transmission method, which is performed by an application function AF and includes:
sending an assistance information request to a second entity, where the assistance information request is used to request the second entity to expose core network assistance information to the AF, the core network assistance information exposed to the AF is determined by the second entity based at least on access configuration information, and the core network assistance information is associated with user equipment UE.

In an embodiment, the access configuration information includes at least one of following:
UE configuration information;
a local policy pre-stored in the second entity.

In an embodiment, the assistance information request includes at least one of following:
identity information of the UE;
a UE group identifier associated with the UE.

In an embodiment, the method further includes:
receiving the core network assistance information exposed to the AF and sent by the second entity.

In an embodiment, the core network assistance information exposed to the AF and sent by the second entity is sent in a security protection manner, and the security protection manner is indicated by the access configuration information.

In an embodiment, the method further includes:
in response to the AF being an operator-deployed AF or a trusted AF, determining, according to received UE configuration information, whether the core network assistance information is exposed to the operator-deployed AF or the trusted AF;
where sending the assistance information request to the second entity includes:
sending, in response to determining that the core network assistance information is exposed to the operator-deployed AF or the trusted AF, the assistance information request to the second entity.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes user consent information, and the user consent information is used to indicate that a user of the UE agrees to expose the core network assistance information to the AF.

According to a fifth aspect of embodiments of the present disclosure, there is provided an information transmission method, which is performed by a core network and includes:
receiving, by a first entity of the core network, UE configuration information sent by user equipment UE, where the UE configuration information is used to determine core network assistance information exposed to an application function AF, and the core network assistance information is associated with the UE.

In an embodiment, the method further includes:
determining, by a second entity of the core network based at least on access configuration information, whether to expose the core network assistance information to the AF, where the core network assistance information is associated with the UE.

In an embodiment, the access configuration information includes: UE configuration information and/or a local policy pre-stored in the second entity, where the UE configuration information is sent by the first entity to the second entity, and the UE configuration information is subscribed or requested by the second entity to the first entity.

In an embodiment, the method further includes:
receiving, by the first entity, UE configuration update information sent by the UE, where the UE configuration update information is used to update the UE configuration information; and
sending, by the first entity, to the second entity an update indication to update the UE configuration information, where the UE configuration information is associated with identity information of the UE.

In an embodiment, the UE configuration update information is used to prohibit the core network assistance information from being exposed to the AF.

In an embodiment, the method further includes:
receiving, by the second entity, an assistance information request of the AF, where the assistance information request is used to request the core network assistance information from the second entity.

In an embodiment, the method further includes at least one of following:
determining, by the second entity based at least on identity information of the UE carried in the assistance information request, the UE configuration information, where the UE configuration information is associated with the identity information of the UE;
determining, by the second entity according to a UE group identifier carried in the assistance information request, identity information of the UE associated with the UE group identifier, and determining the UE configuration information based at least on the determined identity information of the UE.

In an embodiment, the method further includes:
sending, by the second entity to the AF, the core network assistance information exposed to the AF.

In an embodiment, sending, by the second entity to the AF, the core network assistance information that allows the AF to access includes:
sending, by the second entity to the AF, the core network assistance information exposed to the AF in a security protection manner, where the security protection manner is indicated by the access configuration information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

According to a sixth aspect of embodiments of the present disclosure, there is provided an information transmission apparatus, which is provided in user equipment UE and includes:
a first transceiver module, configured to send UE configuration information to a first entity, wherein the UE configuration information is used to determine core network assistance information exposed to an application function AF, and the core network assistance information is associated with the UE.

In an embodiment, the first transceiver module is further configured to: send UE configuration update information to the first entity, where the UE configuration update information is used to update the UE configuration information.

In an embodiment, the UE configuration update information is used to prohibit the core network assistance information from being exposed to the AF.

In an embodiment, the UE configuration information is associated with identity information of the UE; and the UE configuration information is to be sent to a second entity by the first entity.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

According to a seventh aspect of embodiments of the present disclosure, there is provided an information transmission apparatus, which is provided in a first entity and includes: a second transceiver module, configured to receive UE configuration information sent by user equipment UE, wherein the UE configuration information is used to determine core network assistance information exposed to an application function AF, and the core network assistance information is associated with the UE.

In an embodiment, the second transceiver module is further configured to: receive UE configuration update information sent by the UE, where the UE configuration update information is used to update the UE configuration information.

In an embodiment, the UE configuration update information is used to prohibit the core network assistance information from being exposed to the AF.

In an embodiment, the second transceiver module is further configured to: send to a second entity an update indication to update the UE configuration information, where the UE configuration information is associated with identity information of the UE.

In an embodiment, the second transceiver module is further configured to: send the UE configuration information to a second entity, where the UE configuration information is subscribed or requested by the second entity to the first entity.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

According to an eighth aspect of embodiments of the present disclosure, there is provided an information transmission apparatus, which is provided in a second entity and includes:
a first processing module, configured to determine, based at least on access configuration information, whether to expose core network assistance information to an application function AF, wherein the core network assistance information is associated with user equipment UE.

In an embodiment, the apparatus further includes:
a third transceiver module, configured to: receive an assistance information request from the AF, where the assistance information request is used to request the core network assistance information from the second entity.

In an embodiment, the first processing module is further configured to implement at least one of following:
determining UE configuration information based at least on identity information of the UE carried in the assistance information request, where the UE configuration information is associated with the identity information of the UE;
determining, according to a UE group identifier carried in the assistance information request, identity information of the UE associated with the UE group identifier, and determining UE configuration information based at least on the determined identity information of the UE.

In an embodiment, the access configuration information includes: UE configuration information and/or a local policy pre-stored in the second entity; and
the apparatus further includes: a third transceiver module, configured to receive the UE configuration information sent by the first entity.

In an embodiment, the first entity includes at least one of following:
unified data management UDM;
unified data repository function UDR;
an operator-deployed AF or a trusted AF.

In an embodiment, the apparatus further includes: a third transceiver module, configured to:
send to the AF the core network assistance information exposed to the AF.

In an embodiment, the third transceiver module is specifically configured to:
send to the AF the core network assistance information exposed to the AF in a security protection manner, where the security protection manner is indicated by the access configuration information.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes user consent information, and the user consent information is used to indicate that a user of the UE agrees to expose the core network assistance information to the AF.

According to a ninth aspect of embodiments of the present disclosure, there is provided an information transmission apparatus, which is provided in an application function AF and includes:
a fourth transceiver module, configured to send an assistance information request to a second entity, wherein the assistance information request is used to request the second entity to expose core network assistance information to the AF, the core network assistance information exposed to the AF is determined by the second entity based at least on access configuration information, and the core network assistance information is associated with user equipment UE.

In an embodiment, the access configuration information includes at least one of following:
UE configuration information;
a local policy pre-stored in the second entity.

In an embodiment, the assistance information request includes at least one of following:
identity information of the UE;
a UE group identifier associated with the UE.

In an embodiment, the fourth transceiver module is further configured to: receive the core network assistance information exposed to the AF and sent by the second entity.

In an embodiment, the core network assistance information exposed to the AF and sent by the second entity is sent in a security protection manner, and the security protection manner is indicated by the access configuration information.

In an embodiment, the apparatus further includes:
a second processing module, configured to: in response to the AF being an operator-deployed AF or a trusted AF, determine, according to received UE configuration information, whether the core network assistance information is exposed to the operator-deployed AF or the trusted AF;
the fourth transceiver module is specifically configured to:
send, in response to determining that the core network assistance information is exposed to the operator-deployed AF or the trusted AF, the assistance information request to the second entity.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes user consent information, and the user consent information is used to indicate that a user of the UE agrees to expose the core network assistance information to the AF.

According to a tenth aspect of embodiments of the present disclosure, there is provided an information transmission apparatus, which is provided in a core network and includes:
a first entity of the core network, configured to receive UE configuration information sent by user equipment UE, where the UE configuration information is used to determine core network assistance information exposed to an application function AF, and the core network assistance information is associated with the UE.

In an embodiment, a second entity of the core network determines, based at least on access configuration information, whether to expose the core network assistance information to the AF, where the core network assistance information is associated with the UE.

In an embodiment, the access configuration information includes: UE configuration information and/or a local policy pre-stored in the second entity, where the UE configuration information is sent by the first entity to the second entity, and the UE configuration information is subscribed or requested by the second entity to the first entity.

In an embodiment,
the first entity receives UE configuration update information sent by the UE, where the UE configuration update information is used to update the UE configuration information; and
the first entity sends to the second entity an update indication to update the UE configuration information, where the UE configuration information is associated with identity information of the UE.

In an embodiment, the UE configuration update information is used to prohibit the core network assistance information from being exposed to the AF.

In an embodiment,
the second entity receives an assistance information request of the AF, where the assistance information request is used to request the core network assistance information from the second entity.

In an embodiment, the second entity determines, based at least on identity information of the UE carried in the assistance information request, the UE configuration information, where the UE configuration information is associated with the identity information of the UE;
and/or
the second entity determines, according to a UE group identifier carried in the assistance information request, identity information of the UE associated with the UE group identifier, and determines the UE configuration information based at least on the determined identity information of the UE.

In an embodiment, the second entity sends to the AF the core network assistance information exposed to the AF.

In an embodiment, sending, by the second entity to the AF, the core network assistance information that allows the AF to access includes:
sending, by the second entity to the AF, the core network assistance information exposed to the AF in a security protection manner, where the security protection manner is indicated by the access configuration information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

According to an eleventh aspect of embodiments of the present disclosure, a communication device is provided, wherein the communication device includes:
a processor; and
a memory for storing executable instructions of the processor;
where the processor is configured to, upon running the executable instructions, implement the information transmission method according to any one of the first aspect, the second aspect, the third aspect, the fourth aspect, or the fifth aspect.

According to the twelfth aspect of embodiments of the present disclosure, a computer storage medium is provided, where the computer storage medium stores a computer executable program, and the executable program is used for, upon being executed by a processor, implementing the information transmission method according to any one of the first aspect, the second aspect, the third aspect, the fourth aspect, or the fifth aspect.

Based on the information transmission methods, apparatuses, communication device and storage medium according to some embodiments of the present disclosure. UE sends UE configuration information to the first entity, where the UE configuration information is used to determine the core network assistance information exposed to the application function AF, and the core network assistance information is associated with UE. In this way, the UE configuration information can be used to set the permission for the core network assistance information to be exposed to AF, and the privacy of the core network assistance information is protected, thereby improving the security of the core network assistance information.

It is to be understood that the foregoing general description and the following detailed description are exemplary and explanatory only, and are not restrictive of the present disclosure.

### BRIEF DESCRIPTION OF THE DRAWINGS

The accompanying drawings, which are incorporated in and constitute a part of this specification, illustrate some embodiments consistent with the present disclosure and, together with the description, serve to explain the principles of the present disclosure.

FIG. 1 is a schematic structural diagram of a wireless communication system according to an exemplary embodiment.

FIG. 2 is a schematic flow chart of an information transmission method according to an exemplary embodiment.

FIG. 3 is a schematic flow chart of an information transmission method according to an exemplary embodiment.

FIG. 4 is a schematic flow chart of an information transmission method according to an exemplary embodiment.

FIG. 5 is a schematic flow chart of an information transmission method according to an exemplary embodiment.

FIG. 6 is a schematic flow chart of an information transmission method according to an exemplary embodiment.

FIG. 7 is a schematic flow chart of an information transmission method according to an exemplary embodiment.

FIG. 8 is a schematic flow chart of an information transmission method according to an exemplary embodiment.

FIG. 9 is a schematic flow chart of an information transmission method according to an exemplary embodiment.

FIG. 10 is a schematic flow chart of an information transmission method according to an exemplary embodiment.

FIG. 11 is a schematic flow chart of an information transmission method according to an exemplary embodiment.

FIG. 12 is a schematic flow chart of an information transmission method according to an exemplary embodiment.

FIG. 13 is a schematic flow chart of an information transmission method according to an exemplary embodiment.

FIG. 14 is a schematic flow chart of an information transmission method according to an exemplary embodiment.

FIG. 15 is a schematic flow chart of an information transmission method according to an exemplary embodiment.

FIG. 16 is a schematic flow chart of an information transmission method according to an exemplary embodiment.

FIG. 17 is a schematic flow chart of an information transmission method according to an exemplary embodiment.

FIG. 18 is a schematic flow chart of an information transmission method according to an exemplary embodiment.

FIG. 19 is a schematic flow chart of an information transmission method according to an exemplary embodiment.

FIG. 20 is a schematic flow chart of an information transmission method according to an exemplary embodiment.

FIG. 21 is a schematic flow chart of an information transmission method according to an exemplary embodiment.

FIG. 22 is a schematic flow chart of an information transmission method according to an exemplary embodiment.

FIG. 23 is a schematic flow chart of a method for setting a UE configuration file according to an exemplary embodiment.

FIG. 24 is a schematic flow chart of a method for authorizing a UE configuration file according to an exemplary embodiment.

FIG. 25 is a block diagram of an information transmission apparatus according to an exemplary embodiment.

FIG. 26 is a block diagram of an information transmission apparatus according to an exemplary embodiment.

FIG. 27 is a block diagram of an information transmission apparatus according to an exemplary embodiment.

FIG. 28 is a block diagram of an information transmission apparatus according to an exemplary embodiment.

FIG. 29 is a block diagram of an information transmission apparatus according to an exemplary embodiment.

FIG. 30 is a block diagram of UE according to an exemplary embodiment.

FIG. 31 is a block diagram of a base station according to an exemplary embodiment.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present invention. Instead, they are merely examples of apparatuses and methods consistent with some aspects of the embodiments of the present invention as detailed in the appended claims.

The terms used in the disclosed embodiments are only for the purpose of describing specific embodiments and are not intended to limit the disclosed embodiments. The singular forms of “a,” “said” and “the” used in the disclosed embodiments and the appended claims are also intended to include plural forms unless the context clearly indicates other meanings. It should also be understood that the term “and/or” used herein refers to and includes any or all possible combinations of one or more associated listed items.

It should be understood that although the terms “first,” “second,” “third,” etc. may be used to describe various information in the disclosed embodiments, such information should not be limited to these terms. These terms are only used to distinguish the same type of information from each other. For example, without departing from the scope of the disclosed embodiments, the first information may also be referred to as the second information, and similarly, the second information may also be referred to as the first information. Depending on the context, the word “if” as used herein may be interpreted as “when” or “upon” or “in response to determining”.

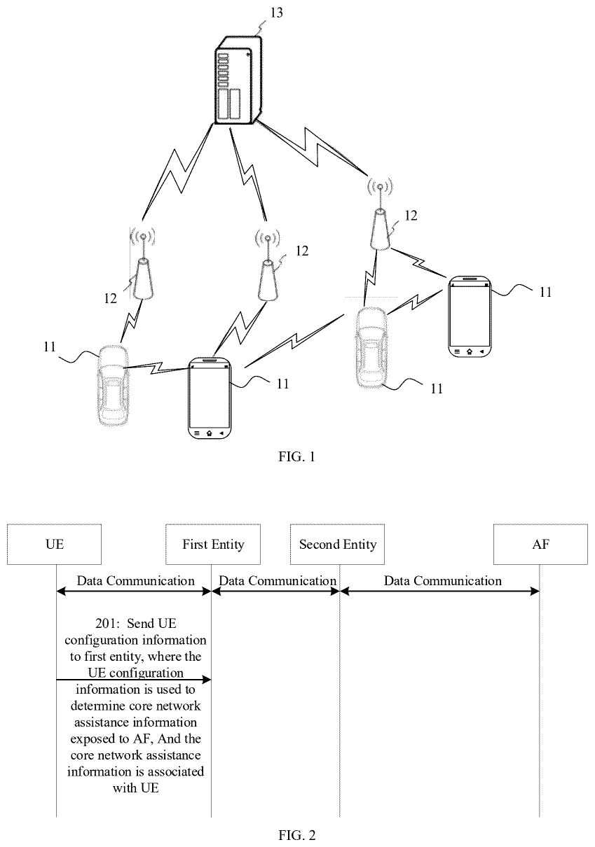

Referring to FIG. 1, which shows a schematic structural diagram of a wireless communication system according to an embodiment of the present disclosure. As shown in FIG. 1, the wireless communication system is a communication system based on cellular mobile communication technology, and the wireless communication system may include: several terminal(s) 11 and several base station(s) 12.

Herein, the terminal 11 can be a device that provides voice and/or data connectivity to the user. The terminal 11 can communicate with one or more core network devices via a radio access network (RAN). The terminal 11 can be an Internet of Things (IOT) terminal, such as a sensor device, a mobile phone (or a “cellular” phone), and a computer with an IoT terminal. For example, it can be a fixed, portable, pocket-sized, handheld, computer-built-in or vehicle-mounted device, such as a station (STA), a subscriber unit, a subscriber station, a mobile station, a mobile, a remote station, an access point, a remote terminal, an access terminal, a user terminal, a user agent, a user device, or user equipment (UE). Alternatively, the terminal 11 can also be a device of an unmanned aerial vehicle. Alternatively, the terminal 11 can also be a vehicle-mounted device. For example, it can be a driving computer with wireless communication function, or a wireless communication device connected to an external driving computer. Alternatively, the terminal 11 may also be a roadside device, for example, a street lamp, a traffic light or other roadside device with a wireless communication function.

The base station 12 may be a network-side device in the wireless communication system. The wireless communication system may be the 4th generation mobile communication (4G) system, also known as a long term evolution (LTE) system; or, the wireless communication system may be a fifth generation mobile communication (5G) system, also known as a new radio (NR) system or a 5G NR system. Alternatively, the wireless communication system may be a next generation system of the 5G system. The access network in the 5G system may be called NG-RAN (New Generation-Radio Access Network). Alternatively, it may be an MTC system.

Herein, the base station 12 can be an evolved NodeB (eNB) adopted in the 4G system. Alternatively, the base station 12 can also be a base station (gNB) adopting a centralized-distributed architecture in the 5G system. When the base station 12 adopts the centralized-distributed architecture, it usually includes a central unit (CU) and at least two distributed units (DUs). The central unit is provided with a protocol stack of a packet data convergence protocol (PDCP) layer, a radio link control (RLC) layer, and a media access control (MAC) layer. The distributed unit is provided with a physical (PHY) layer protocol stack. The specific implementation of the base station 12 is not limited in the embodiments of the present disclosure.

A wireless connection can be established between the base station 12 and the terminal 11 through a wireless air interface. In different implementations, the wireless air interface is a wireless air interface based on the 4G standard; or, the wireless air interface is a wireless air interface based on the 5G standard. For example, the wireless air interface is a new air interface. Alternatively, the wireless air interface can also be a wireless air interface based on the next generation mobile communication network technology standard of 5G.

In some embodiments, an E2E (End to End) connection may also be established between the terminals 11, for example, in the vehicle to everything (V2X) scenarios such as V2V (vehicle to vehicle) communication, V2I (vehicle to Infrastructure) communication, and V2P (vehicle to pedestrian) communication.

In some embodiments, the wireless communication system may further include a network management device 13.

Several base stations 12 are respectively connected to the network management device 13. The network management device 13 may be a core network device in the wireless communication system. For example, the network management device 13 may be a mobility management entity (MME) in an evolved packet core (EPC) network device. Alternatively, the network management device may also be other core network devices, such as a serving gateway (SGW), a public data network gateway (PGW), a policy and charging rules function (PCRF), a home subscriber server (HSS), or the like. The embodiments of the present disclosure do not limit the implementations of the network management device 13.

In order to facilitate the understanding of those skilled in the art, the embodiments of the present disclosure list multiple implementations to clearly illustrate the technical solutions of the embodiments of the present disclosure. Those skilled in the art can understand that the multiple implementations provided by the embodiments of the present disclosure can be executed separately, or can be executed together with the methods according to other implementations of the embodiments of the present disclosure, or can be executed together with some other methods in related art separately or in combination, which are not limited in the embodiments of the present disclosure.

5GC may need to determine which core network assistance information is required by AF to complete AI/ML operations. Currently, there is no mechanism for the core network to determine whether it can authorize the exposure of core network assistance information to AF while avoiding the exposure of information that is not necessary for AI/ML operations.

Therefore, how to protect the privacy of core network assistance information in the process of exposing the core network assistance information to AF is an urgent problem to be solved.

As shown in FIG. 2, some exemplary embodiments provide an information transmission method, which may be performed by user equipment UE and includes followings.

In step 201, UE configuration information is sent to a first entity, where the UE configuration information is used to determine core network assistance information exposed to AF, and the core network assistance information is associated with UE.

The information transmission method performed by UE proposed in some embodiments of the present disclosure corresponds to some embodiments of the first entity side and/or the second entity side and/or the AF side, so the same explanations or features will not be repeated one by one, and reference can be made to the embodiments of the corresponding sides.

The first entity may be a network entity for storing and distributing core network assistance information. UE may send the UE configuration information to the first entity. When AF is to access the core network assistance information, authorization confirmation may be performed based on the UE configuration information stored in the first entity, that is, it is determined whether AF can access the core network assistance information.

The second entity may be a network entity for sending core network assistance information to AF. The second entity may obtain UE configuration information from the first entity and determine the core network assistance information exposed to AF.

AF may request the core network assistance information from the second entity by means of a request or the like. The second entity may determine the core network assistance information exposed to AF based on the UE configuration information, and send to AF the core network assistance information exposed to AF.

AF can perform subsequent processing, such as AI/ML processing, based on the acquired core network assistance information.

AF can be an application server.

In a possible implementation, UE sends the UE configuration information to the first entity through an access network device.

In a possible implementation, UE sends the UE configuration information to the first entity through an access network device and a core network element (e.g., AMF).

The core network assistance information exposed to the application function AF may be the core network assistance information that AF is authorized to access. The core network assistance information that AF is authorized to access may include: the core network assistance information that AF is authorized to request and/or the core network assistance information that AF is authorized to modify.

In an embodiment, the first entity includes at least one of the following:
unified data management (UDM);
unified data repository function (UDR);
an operator-deployed AF or a trusted AF.

Here, the operator-deployed AF or the trusted AF is different from other AFs. The operator-deployed AF or the trusted AF is an AF trusted by the core network and has the authority to store and distribute the core network assistance information.

In a possible implementation, the UE configuration information is also used to determine the core network assistance information exposed to the operator-deployed AF or the trusted AF.

In a possible implementation, the UE configuration information may be used to indicate the core network assistance information exposed to AF.

In a possible implementation, the UE configuration information may be used to indicate core network assistance information that is not exposed to AF.

In an embodiment, the UE configuration information includes user consent information, where the user consent information is used to indicate that the user of UE agrees to expose the core network assistance information to the application function AF.

The core network assistance information may be information used by AF to perform AI/ML processing.

In an embodiment, the UE configuration information includes at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;
protection policy information of the core network assistance information.

Here, the UE configuration information may be associated with the core network assistance information exposed to AF, and/or the UE configuration information may be associated with the core network assistance information not exposed to AF.

In a possible implementation, the identity information of AF is associated with AF authorized to access the core network assistance information; or the identity information of AF is associated with AF not authorized to access the core network assistance information.

In a possible implementation, the identity information of AF may include at least one of the following: identity information of an authorized AF; identity information of an unauthorized AF.

In a possible implementation, the identity information of AF is used to indicate at least one of the following: AF_ID, application layer identifier (ID), and a fully qualified domain name (FQDN).

In a possible implementation, the service identity information is associated with a service that is authorized to access the core network assistance information and/or a service that is not authorized to access the core network assistance information.

In a possible implementation, the identity information of UE is used to indicate at least one of the following: a subscription permanent identifier (SUPI), a subscription concealed identifier (SUCI), an IP multimedia private identity (IMPI), an application layer ID of UE, and a generic public subscription identifier (GPSI).

In a possible implementation, the group identity information of UE includes but is not limited to at least one of the following: external group identifier; group identifier; personal IoT network ID (PIN ID); external PIN ID, internal PIN ID.

In a possible implementation, AI/ML operational information is used to indicate at least one of the following: model training, model segmentation, and inference feedback.

In a possible implementation, the authorization policy information of the core network assistance information is used to indicate at least one of the following: an AF that can access and/or modify the preset core network assistance information.

The data type of the core network assistance information may be divided based on one of the following: service, data attribute. For example, the data type includes: location information, time information.

Exemplarily, the data type and detailed content of the core network assistance information are shown in Table 1 (the core network assistance information here can be 5G core network assistance information).

TABLE 1

| | Data Type | |
|---|---|---|
| | 5G Assistance Information | Detailed Data |
| Data Source | Type | Detailed 5G Assistance Information |
| UE-related data | UE Status | Network authorization status of the |
| | UE status information | UE |
| | | Network authorization status of the |
| | | UE |
| | | Radio link quality (RSRP) |
| | | RSRP of UE |
| | UE location | TAI |
| | UE location information | Tranck area identity of UE |
| 5GC-related data | Prediction Information | Packet loss rate prediction |
| | UE-related prediction | UE-related packet loss rate |
| | information | prediction |
| | | Network congestion prediction |
| | | UE-related network congestion |
| | | prediction |
| | | Network load predictions at UE |
| | | locations |
| | | UE-related network load prediction |
| | Slicing Information | S-NSSAI |
| | UE-related slicing | UE-related slicing information |
| | information | |
| Network-assisted | Congestion | User data congestion time prediction |
| data | UE-related congestion | UE-related user data congestion time |
| | information | prediction |
| | QoS | QoS Sustainability Analytics |
| | UE-related QoS | (NWDAF) |
| | information | UE-related QoS analytics data |

In a possible implementation, the protection policy information is at least used to indicate a protection manner used for the core network assistance information during transmission. The protection manner includes but is not limited to at least one of the following: anonymization and differential privacy.

Exemplarily, taking the first entity as UDM as an example, if UE has generated or updated the UE configuration information, UE carries the UE configuration information in the N1 NAS message and sends it to AMF.

AMF calls Nudm_ParameterProvision_Update service operation to UDM, where the service operation carries the UE configuration information. UDM stores the UE configuration information by calling Nudr_DM_Update (SUPI, subscription data) service operation accordingly.

AMF responds to UE through the UE configuration information setting response in the N1 NAS message, determines that the operation is successful, and the like.

In this way, the permission to expose the core network assistance information to AF can be set through the UE configuration information, the privacy of the core network assistance information is protected, and the security of the core network assistance information is improved.

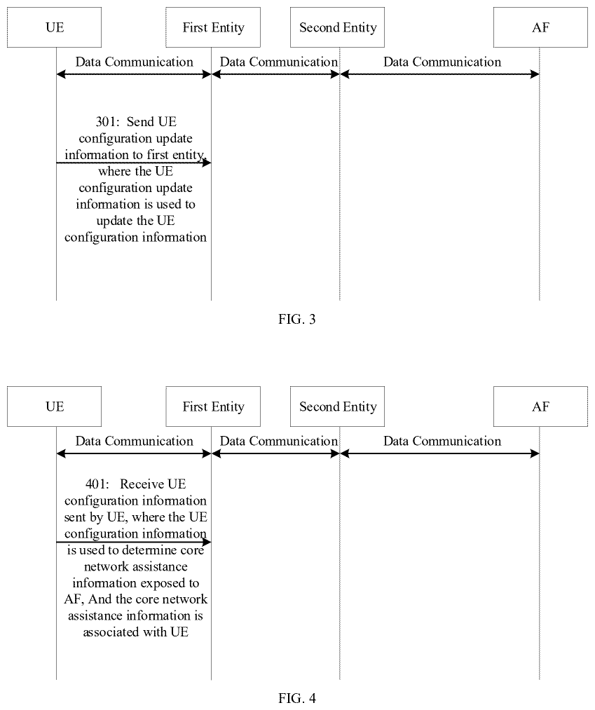

As shown in FIG. 3, some exemplary embodiments provide an information transmission method, which may be performed by user equipment UE and includes followings.

In step 301, UE configuration update information is sent to the first entity, where UE configuration update information is used to update the UE configuration information.

UE may determine the UE configuration information and update the UE configuration information. UE may update the UE configuration information through the UE configuration update information.

The updating of the UE configuration information includes but is not limited to one of the following: modifying the content in the UE configuration information; deleting the content in the UE configuration information; adding content in the UE configuration information.

In a possible implementation, the UE configuration update information may be sent to the first entity in the same manner as the UE configuration information.

Exemplarily, taking the first entity as UDM as an example, if UE has updated the UE configuration information, UE carries the UE configuration update information in the N1 NAS message and sends it to AMF.

AMF calls the Nudm_ParameterProvision_Update service operation to UDM, where the service operation carries the UE configuration update information. UDM updates the stored UE configuration information by calling the Nudr_DM_Update (SUPI, Subscription Data) service operation accordingly. AMF responds to UE with the UE configuration information set response in the N1 NAS message, thereby confirming that the operation is successful, and the like.

In an embodiment, the UE configuration update information is used to prohibit the core network assistance information from being exposed to AF.

In a possible implementation, the UE configuration update information may prohibit the core network assistance information from being exposed to AF by updating the UE configuration information.

In a possible implementation, the UE configuration update information may directly indicate that the core network assistance information is prohibited from being exposed to AF.

In an embodiment, the UE configuration information is associated with identity information of UE.

When referring to that the UE configuration information is associated with the identity information of UE, it may mean that the UE configuration information is UE configuration information of UE identified by the identity information of UE.

A network entity, such as a second entity, and the like, may determine the UE configuration information of UE based on the identity information of UE.

In an embodiment, the UE configuration information is to be sent by the first entity to the second entity.

The second entity may be a network entity for managing the core network assistance information and sending the core network assistance information to AF.

In a possible implementation, the second entity may subscribe to the UE configuration information from the first entity.

In a possible implementation, in response to the second entity subscribing to the first entity for the UE configuration information, the first entity may send the UE configuration information to the second entity.

In a possible implementation, in response to the second entity subscribing to the first entity for the UE configuration information, when the first entity determines that the UE configuration information is updated, it may send a notification of updating the UE configuration information to the second entity.

Exemplarily, the second entity may subscribe to a UDM notification of the UE configuration information update. UDM notifies the subscribed second entity of the updated UE configuration information through the Nudm_SDM_Notification Notify message. The second entity may unsubscribe to the UDM notification of the UE configuration information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

AF may request core network assistance information from the second entity by sending an assistance information request to the second entity, and the second entity may determine the core network assistance information exposed to AF based on the UE configuration information, and send to AF the core network assistance information exposed to AF.

In a possible implementation, the assistance information request may request core network assistance information.

In a possible implementation, the assistance information request includes but is not limited to at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;

The assistance information request requests specific content of the core network assistance information, and its specific expression is similar to the core network assistance information, which will not be repeated here.

In a possible implementation, the second entity may query UE assistance information according to at least one item in the assistance information request, and determine the authorization policy of the core network assistance information for AF.

In a possible implementation, the second entity may query UE assistance information according to at least one item in the assistance information request, so as to determine the protection policy of the core network assistance information with respect to AF. After receiving the assistance information request from AF, the second entity may determine the access authority of AF based on the access configuration information, determine the core network assistance information exposed to AF, and send to AF the core network assistance information exposed to AF.

Embodiments of the present disclosure further propose an information transmission method performed by the first entity. It should be noted that, such method corresponds to the embodiments on the UE side and/or the second entity side and/or the AF side, so the same explanations or features will not be repeated one by one, and reference can be made to the embodiments on the corresponding side(s).

As shown in FIG. 4, some exemplary embodiments provide an information transmission method, which may be performed by a first entity and includes followings.

In step 401, UE configuration information sent by user equipment UE is received, where the UE configuration information is used to determine core network assistance information exposed to AF, and the core network assistance information is associated with UE.

The first entity may be a network entity for storing and distributing core network assistance information. UE may send the UE configuration information to the first entity. When AF is to access the core network assistance information, authorization confirmation may be performed based on the UE configuration information stored in the first entity, that is, it is determined whether AF can access the core network assistance information.

The second entity may be a network entity for sending core network assistance information to AF. The second entity may obtain UE configuration information from the first entity and determine the core network assistance information exposed to AF.

AF may request the core network assistance information from the second entity by means of a request or the like. The second entity may determine the core network assistance information exposed to AF based on the UE configuration information, and send to AF the core network assistance information exposed to AF.

AF can perform subsequent processing, such as AI/ML processing, based on the acquired core network assistance information.

AF can be an application server.

In a possible implementation, UE sends the UE configuration information to the first entity through an access network device.

In a possible implementation, UE sends the UE configuration information to the first entity through an access network device and a core network element (e.g., AMF).

The core network assistance information exposed to the application function AF may be the core network assistance information that AF is authorized to access. The core network assistance information that AF is authorized to access may include: the core network assistance information that AF is authorized to request and/or the core network assistance information that AF is authorized to modify.

In an embodiment, the first entity includes at least one of the following:
unified data management (UDM);
unified data repository function (UDR);
an operator-deployed AF or a trusted AF.

Here, the operator-deployed AF or the trusted AF is different from other AFs. The operator-deployed AF or the trusted AF is an AF trusted by the core network and has the authority to store and distribute the core network assistance information.

In a possible implementation, the UE configuration information is also used to determine the core network assistance information exposed to the operator-deployed AF or the trusted AF.

In a possible implementation, the UE configuration information may be used to indicate the core network assistance information exposed to AF.

In a possible implementation, the UE configuration information may be used to indicate core network assistance information that is not exposed to AF.

In an embodiment, the UE configuration information includes user consent information, where the user consent information is used to indicate that the user of UE agrees to expose the core network assistance information to the application function AF.

The core network assistance information may be information used by AF to perform AI/ML processing.

In an embodiment, the UE configuration information includes at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;
protection policy information of the core network assistance information.

Here, the UE configuration information may be associated with the core network assistance information exposed to AF, and/or the UE configuration information may be associated with the core network assistance information not exposed to AF.

In a possible implementation, the identity information of AF is associated with AF being authorized to access the core network assistance information, or the identity information of AF is associated with AF not being authorized to access the core network assistance information.

In a possible implementation, the identity information of AF may include at least one of the following: identity information of an authorized AF; identity information of an unauthorized AF.

In a possible implementation, the identity information of AF is used to indicate at least one of the following: AF_ID, application layer identifier (ID), and a fully qualified domain name (FQDN).

In a possible implementation, the service identity information is associated with a service that is authorized to access the core network assistance information and/or a service that is not authorized to access the core network assistance information.

In a possible implementation, the identity information of UE is used to indicate at least one of the following: a subscription permanent identifier (SUPI), a subscription concealed identifier (SUCI), an IP multimedia private identity (IMPI), an application layer ID of UE, and a generic public subscription identifier (GPSI).

In a possible implementation, the group identity information of UE includes but is not limited to at least one of the following: external group identifier; group identifier; personal IoT network ID (PIN ID); external PIN ID, internal PIN ID.

In a possible implementation, AI/ML operational information is used to indicate at least one of the following: model training, model segmentation, and inference feedback.

In a possible implementation, the authorization policy information of the core network assistance information is used to indicate at least one of the following: an AF that can access and/or modify the preset core network assistance information.

The data type of the core network assistance information may be divided based on one of the following: service, data attribute. For example, the data type includes: location information, time information.

Exemplarily, the data type and detailed content of the core network assistance information are shown in Table 1 (the core network assistance information here can be 5G core network assistance information).

In a possible implementation, the protection policy information is at least used to indicate a protection manner used for the core network assistance information during transmission. The protection manner includes but is not limited to at least one of the following: anonymization and differential privacy.

Exemplarily, taking the first entity as UDM as an example, if UE has generated or updated the UE configuration information, UE carries the UE configuration information in the N1 NAS message and sends it to AMF.

AMF calls Nudm_ParameterProvision_Update service operation to UDM, where the service operation carries the UE configuration information. UDM stores the UE configuration information by calling Nudr_DM_Update (SUPI, subscription data) service operation accordingly.

AMF responds to UE through the UE configuration information setting response in the N1 NAS message, determines that the operation is successful, and the like.

In this way, the permission to expose the core network assistance information to AF can be set through the UE configuration information, the privacy of the core network assistance information is protected, and the security of the core network assistance information is improved.

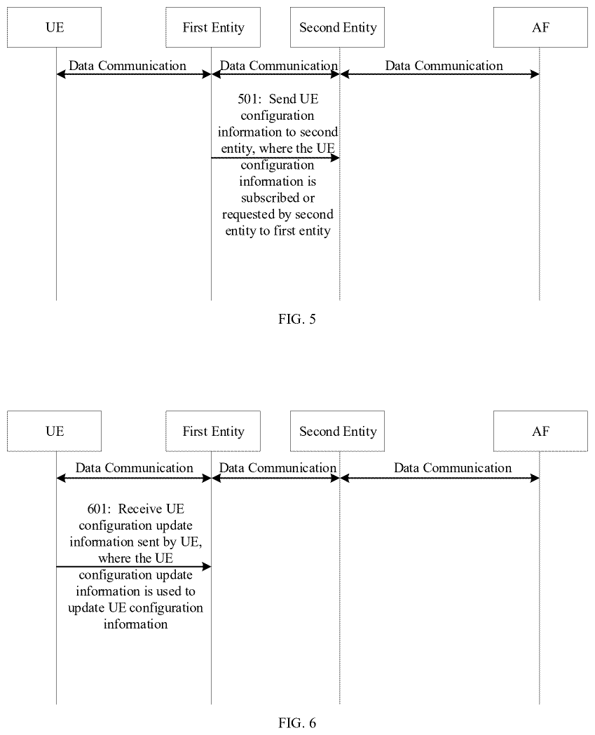

As shown in FIG. 5, some exemplary embodiments provide an information transmission method, which may be performed by a first entity and includes followings.

In step 501, UE configuration information is sent to a second entity, where the UE configuration information is subscribed or requested by the second entity to the first entity.

The second entity may be a network entity for managing core network assistance information and sending the core network assistance information to AF.

In a possible implementation, the second entity may subscribe to the UE configuration information from the first entity.

In a possible implementation, in response to the second entity subscribing to the first entity for the UE configuration information, the first entity may send the UE configuration information to the second entity.

In a possible implementation, in response to the second entity subscribing to the first entity for the UE configuration information, when the first entity determines that the UE configuration information is updated, a notification of updating the UE configuration information may be sent to the second entity.

Exemplarily, the second entity may subscribe to the UDM notification of updating the UE configuration information. UDM notifies the subscribed second entity of the updated UE configuration information through the Nudm_SDM_Notification Notify message. The second entity may unsubscribe from the UDM notification of the UE configuration information.

As shown in FIG. 6, some exemplary embodiments provide an information transmission method, which may be performed by a first entity and includes followings.

In step 601, UE configuration update information sent by UE is received, where the UE configuration update information is used to update the UE configuration information.

UE may determine the UE configuration information and update the UE configuration information. UE may update the UE configuration information through the UE configuration update information.

The updating of the UE configuration information includes but is not limited to one of the following: modifying the content in the UE configuration information; deleting the content in the UE configuration information; adding content in the UE configuration information.

In a possible implementation, the UE configuration update information may be sent to the first entity in the same manner as the UE configuration information.

Exemplarily, taking the first entity as UDM as an example, if UE has updated the UE configuration information, UE carries the UE configuration update information in the N1 NAS message and sends it to AMF.

AMF calls the Nudm_ParameterProvision_Update service operation to UDM, where the service operation carries the UE configuration update information. UDM updates the stored UE configuration information by calling the Nudr_DM_Update (SUPI, Subscription Data) service operation accordingly. AMF responds to UE with the UE configuration information set response in the N1 NAS message, thereby confirming that the operation is successful, and the like.

In an embodiment, the UE configuration update information is used to prohibit the core network assistance information from being exposed to AF.

In a possible implementation, the UE configuration update information may prohibit the core network assistance information from being exposed to AF by updating the UE configuration information.

In a possible implementation, the UE configuration update information may directly indicate that the core network assistance information is prohibited from being exposed to AF.

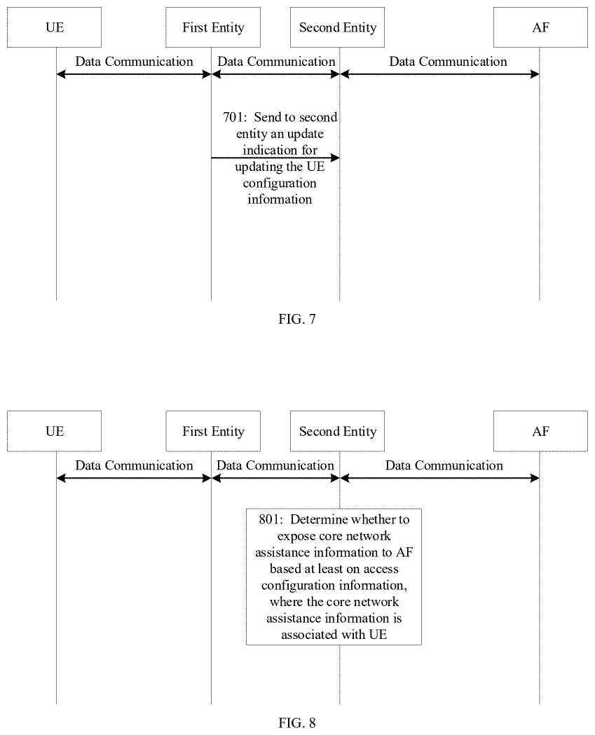

As shown in FIG. 7, some exemplary embodiments provide an information transmission method, which may be performed by a first entity and includes followings.

In step 701, an update indication for updating the UE configuration information is sent to the second entity.

After updating the UE configuration information, the first entity may send an update indication to the second entity. The update indication may carry updated UE configuration information and/or updated content of the UE configuration information.

In an embodiment, the UE configuration information is associated with identity information of UE.

When referring to that the UE configuration information is associated with the identity information of UE, it may mean that the UE configuration information is UE configuration information of UE identified by the identity information of UE.

A network entity, such as a second entity, and the like, may determine the UE configuration information of UE based on the identity information of UE.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

AF may request core network assistance information from the second entity by sending an assistance information request to the second entity, and the second entity may determine the core network assistance information exposed to AF based on the UE configuration information, and send to AF the core network assistance information exposed to AF.

In a possible implementation, the assistance information request may request core network assistance information.

In a possible implementation, the assistance information request includes but is not limited to at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;

The assistance information request requests specific content of the core network assistance information, and its specific expression is similar to the core network assistance information, which will not be repeated here.

In a possible implementation, the second entity may query UE assistance information according to at least one item in the assistance information request, and determine the authorization policy of the core network assistance information for AF.

In a possible implementation, the second entity may query UE assistance information according to at least one item in the assistance information request, so as to determine the protection policy of the core network assistance information with respect to AF. After receiving the assistance information request from AF, the second entity may determine the access authority of AF based on the access configuration information, determine the core network assistance information exposed to AF, and send to AF the core network assistance information exposed to AF.

Embodiments of the present disclosure further propose an information transmission method performed by the second entity. It should be noted that, such method corresponds to the embodiments on the UE side and/or the first entity side and/or the AF side, so the same explanations or features will not be repeated one by one, and reference can be made to the embodiments on the corresponding side(s).

As shown in FIG. 8, some exemplary embodiments provide an information transmission method, which may be performed by a second entity and includes followings.

In step 801, it is determined whether to expose core network assistance information to an application function AF based at least on access configuration information, where the core network assistance information is associated with user equipment UE.

The access configuration information may be pre-stored in the second entity, or may be sent to the second entity by other entities, such as the first entity.

The first entity may be a network entity for storing and distributing core network assistance information. UE may send the UE configuration information to the first entity. When AF is to access the core network assistance information, authorization confirmation may be performed based on the UE configuration information stored in the first entity, that is, it is determined whether AF can access the core network assistance information.

The second entity may be a network entity for sending core network assistance information to AF. The second entity may obtain UE configuration information from the first entity and determine the core network assistance information exposed to AF.

AF may request the core network assistance information from the second entity by means of a request or the like. The second entity may determine the core network assistance information exposed to AF based on the UE configuration information, and send to AF the core network assistance information exposed to AF.

AF can perform subsequent processing, such as AI/ML processing, based on the acquired core network assistance information.

In a possible implementation, the access configuration information includes at least one item of: UE configuration information; and a local policy pre-stored in the second entity.

As shown in FIG. 9, some exemplary embodiments provide an information transmission method, which may be performed by a second entity and includes followings.

In step 901, UE configuration information sent by a first entity is received, where the access configuration information includes: the UE configuration information.

In a possible implementation, UE sends the UE configuration information to the first entity through an access network device.

In a possible implementation, UE sends the UE configuration information to the first entity through an access network device and a core network element (e.g., AMF).

The core network assistance information exposed to the application function AF may be the core network assistance information that AF is authorized to access. The core network assistance information that AF is authorized to access may include: the core network assistance information that AF is authorized to request and/or the core network assistance information that AF is authorized to modify.

In an embodiment, the access configuration information includes: a local policy pre-stored in the second entity.

In a possible implementation, the local policy pre-stored in the second entity is different from or the same as the UE configuration information.

The local policy pre-stored in the second entity and the UE configuration information may indicate the core network assistance information exposed to AF, and/or indicate the core network assistance information not exposed to AF.

In response to the local policy pre-stored in the second entity and the UE configuration information having different indications for the same core network assistance information, the priority of the local policy pre-stored in the second entity and the UE configuration information may be pre-defined, with the indication of the higher priority prevailing.

In an embodiment, the first entity includes at least one of the following:
unified data management (UDM);
unified data repository function (UDR);
an operator-deployed AF or a trusted AF.

Here, the operator-deployed AF or the trusted AF is different from other AFs. The operator-deployed AF or the trusted AF is an AF trusted by the core network and has the authority to store and distribute the core network assistance information.

In a possible implementation, the UE configuration information is also used to determine the core network assistance information exposed to the operator-deployed AF or the trusted AF.

In a possible implementation, the UE configuration information may be used to indicate the core network assistance information exposed to AF.

In a possible implementation, the UE configuration information may be used to indicate core network assistance information that is not exposed to AF.

In an embodiment, the UE configuration information includes user consent information, where the user consent information is used to indicate that the user of UE agrees to expose the core network assistance information to the application function AF.

The core network assistance information may be information used by AF to perform AI/ML processing.

In an embodiment, the UE configuration information includes at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;
protection policy information of the core network assistance information.

Here, the UE configuration information may be associated with the core network assistance information exposed to AF, and/or the UE configuration information may be associated with the core network assistance information not exposed to AF.

In a possible implementation, the identity information of AF is associated with AF being authorized to access the core network assistance information, or the identity information of AF is associated with AF not being authorized to access the core network assistance information.

In a possible implementation, the identity information of AF may include at least one of the following: identity information of an authorized AF; identity information of an unauthorized AF.

In a possible implementation, the identity information of AF is used to indicate at least one of the following: AF_ID, application layer identifier (ID), and a fully qualified domain name (FQDN).

In a possible implementation, the service identity information is associated with a service that is authorized to access the core network assistance information and/or a service that is not authorized to access the core network assistance information.

In a possible implementation, the identity information of UE is used to indicate at least one of the following: a subscription permanent identifier (SUPI), a subscription concealed identifier (SUCI), an IP multimedia private identity (IMPI), an application layer ID of UE, and a generic public subscription identifier (GPSI).

In a possible implementation, the group identity information of UE includes but is not limited to at least one of the following: external group identifier; group identifier; personal IoT network ID (PIN ID); external PIN ID, internal PIN ID.

In a possible implementation, AI/ML operational information is used to indicate at least one of the following: model training, model segmentation, and inference feedback.

In a possible implementation, the authorization policy information of the core network assistance information is used to indicate at least one of the following: an AF that can access and/or modify the preset core network assistance information.

The data type of the core network assistance information may be divided based on one of the following: service, data attribute. For example, the data type includes: location information, time information.

Exemplarily, the data type and detailed content of the core network assistance information are shown in Table 1 (the core network assistance information here can be 5G core network assistance information).

In a possible implementation, the protection policy information is at least used to indicate a protection manner used for the core network assistance information during transmission. The protection manner includes but is not limited to at least one of the following: anonymization and differential privacy.

Exemplarily, taking the first entity as UDM as an example, if UE has generated or updated the UE configuration information, UE carries the UE configuration information in the N1 NAS message and sends it to AMF.

AMF calls Nudm_ParameterProvision_Update service operation to UDM, where the service operation carries the UE configuration information. UDM stores the UE configuration information by calling Nudr_DM_Update (SUPI, subscription data) service operation accordingly.

AMF responds to UE through the UE configuration information setting response in the N1 NAS message, determines that the operation is successful, and the like.

In this way, the permission to expose the core network assistance information to AF can be set through the access configuration information, the privacy of the core network assistance information is protected, and the security of the core network assistance information is improved.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

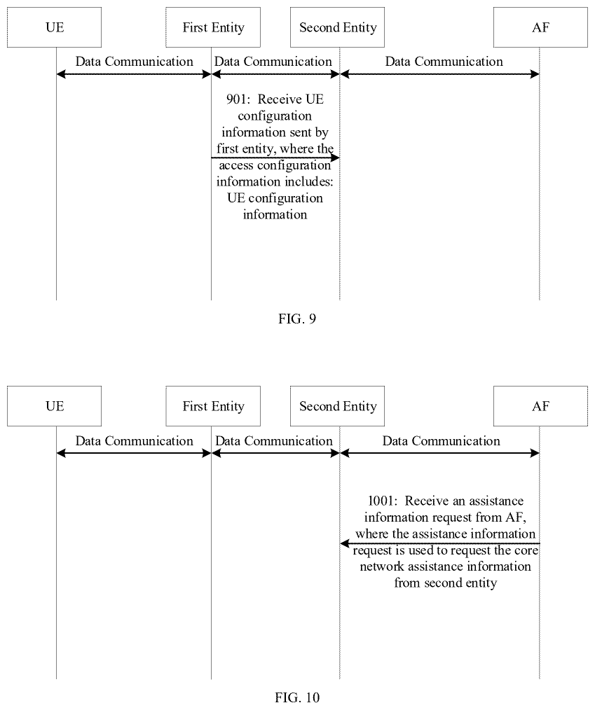

As shown in FIG. 10, some exemplary embodiments provide an information transmission method, which may be performed by a second entity and includes followings.

In step 1001, an assistance information request is received from AF, where the assistance information request is used to request core network assistance information from the second entity.

AF may request core network assistance information from the second entity by sending an assistance information request to the second entity, and the second entity may determine the core network assistance information exposed to AF based on the UE configuration information, and send to AF the core network assistance information exposed to AF.

In a possible implementation, the assistance information request may request core network assistance information.

In a possible implementation, the assistance information request includes but is not limited to at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;

The assistance information request requests specific content of the core network assistance information, and its specific expression is similar to the core network assistance information, which will not be repeated here.

In a possible implementation, the second entity may query UE assistance information according to at least one item in the assistance information request, and determine the authorization policy of the core network assistance information for AF.

In a possible implementation, the second entity may query UE assistance information according to at least one item in the assistance information request, so as to determine the protection policy of the core network assistance information with respect to AF. After receiving the assistance information request from AF, the second entity may determine the access authority of AF based on the access configuration information, determine the core network assistance information exposed to AF, and send to AF the core network assistance information exposed to AF.

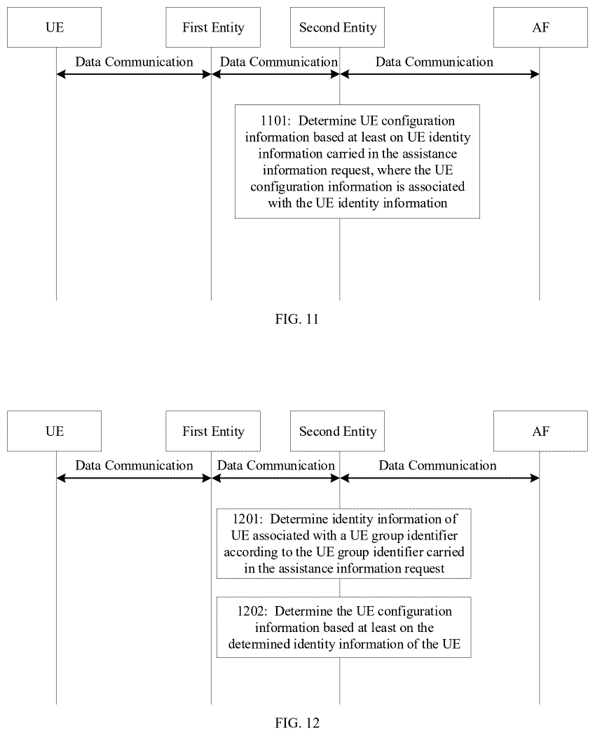

As shown in FIG. 11, some exemplary embodiments provide an information transmission method, which may be performed by a second entity and includes followings.

In step 1101, UE configuration information is determined based at least on UE identity information carried in the assistance information request, where the UE configuration information is associated with UE identity information.

When referring to that the UE configuration information is associated with the identity information of UE, it may mean that the UE configuration information is UE configuration information of UE identified by the identity information of UE.

A network entity, such as a second entity, and the like, may determine the UE configuration information of UE based on the identity information of UE.

As shown in FIG. 12, some exemplary embodiments provide an information transmission method, which may be performed by a second entity and includes followings.

In step 1201, identity information of UE associated with UE group identifier is determined according to the UE group identifier carried in the assistance information request.

In step 1202, the UE configuration information is determined based at least on the determined identity information of UE.

The identity information of UE associated with UE group identifier may include identity information corresponding to UE belonging to a UE group identified by the UE group identifier.

The second entity may determine the corresponding UE configuration information based on the identity information of UE in the UE group, and further determine the core network assistance information exposed to AF.

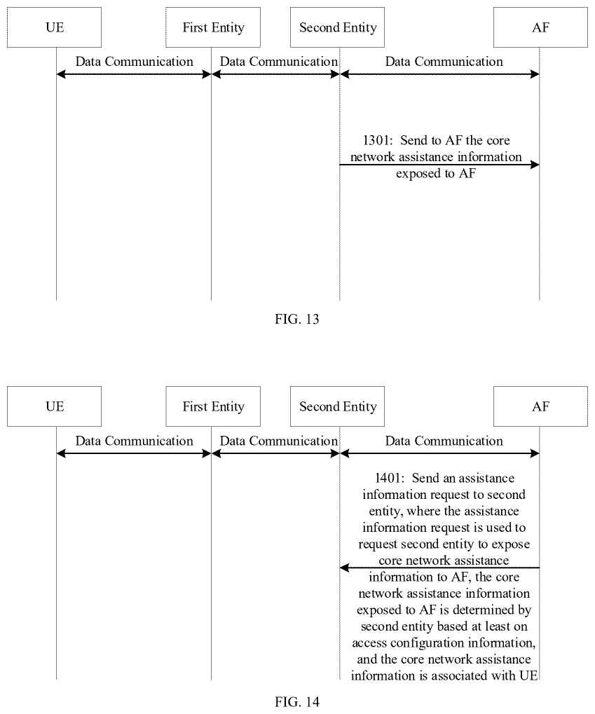

As shown in FIG. 13, some exemplary embodiments provide an information transmission method, which may be performed by a second entity and includes followings.

In step 1301, core network assistance information exposed to AF is sent to AF.

After determining the core network assistance information to be exposed to AF based on the access configuration information, the second entity can send the core network assistance information to AF.

Since the core network assistance information sent to AF is authorized through the access configuration information, privacy of the core network assistance information is protected, thereby improving the security of the core network assistance information.

In an embodiment, sending, to AF, the core network assistance information that allows AF to access includes:

sending to AF the core network assistance information exposed to AF in a security protection manner, where the security protection manner is indicated by the access configuration information.

In a possible implementation, the security protection manner includes at least one of the following: differential privacy, and anonymization.

Embodiments of the present disclosure further propose an information transmission method performed by AF. It should be noted that, such method corresponds to the embodiments on the UE side and/or the first entity side and/or the send entity side, so the same explanations or features will not be repeated one by one, and reference can be made to the embodiments on the corresponding side(s).

As shown in FIG. 14, some exemplary embodiments provide an information transmission method, which may be performed by an application function AF and includes followings.

In step 1401, an assistance information request is sent to a second entity, where the assistance information request is used to request the second entity to expose core network assistance information to AF, the core network assistance information exposed to AF is determined by the second entity based at least on access configuration information, and the core network assistance information is associated with UE.

The first entity may be a network entity for storing and distributing core network assistance information. UE may send the UE configuration information to the first entity. When AF is to access the core network assistance information, authorization confirmation may be performed based on the UE configuration information stored in the first entity, that is, it is determined whether AF can access the core network assistance information.

The second entity may be a network entity for sending core network assistance information to AF. The second entity may obtain UE configuration information from the first entity and determine the core network assistance information exposed to AF.

AF may request the core network assistance information from the second entity by means of a request or the like. The second entity may determine the core network assistance information exposed to AF based on the UE configuration information, and send to AF the core network assistance information exposed to AF.

AF can perform subsequent processing, such as AI/ML processing, based on the acquired core network assistance information.

AF can be an application server.

In an embodiment, the access configuration information includes at least one of the following:
UE configuration information; and
a local policy pre-stored in the second entity.

In a possible implementation, UE sends the UE configuration information to the first entity through an access network device.

In a possible implementation, UE sends the UE configuration information to the first entity through an access network device and a core network element (e.g., AMF).

The core network assistance information exposed to the application function AF may be the core network assistance information that AF is authorized to access. The core network assistance information that AF is authorized to access may include: the core network assistance information that AF is authorized to request and/or the core network assistance information that AF is authorized to modify.

In a possible implementation, the local policy pre-stored in the second entity is different from or the same as the UE configuration information.

The local policy pre-stored in the second entity and the UE configuration information may indicate the core network assistance information exposed to AF, and/or indicate the core network assistance information not exposed to AF.

In response to the local policy pre-stored in the second entity and the UE configuration information having different indications for the same core network assistance information, the priority of the local policy pre-stored in the second entity and the UE configuration information may be pre-defined, with the indication of the higher priority prevailing.

In an embodiment, the first entity includes at least one of the following:
unified data management (UDM);
unified data repository function (UDR);
an operator-deployed AF or a trusted AF.

Here, the operator-deployed AF or the trusted AF is different from other AFs. The operator-deployed AF or the trusted AF is an AF trusted by the core network and has the authority to store and distribute the core network assistance information.

In a possible implementation, the UE configuration information is also used to determine the core network assistance information exposed to the operator-deployed AF or the trusted AF.

In a possible implementation, the UE configuration information may be used to indicate the core network assistance information exposed to AF.

In a possible implementation, the UE configuration information may be used to indicate core network assistance information that is not exposed to AF.

In an embodiment, the UE configuration information includes user consent information, where the user consent information is used to indicate that the user of UE agrees to expose the core network assistance information to the application function AF.

The core network assistance information may be information used by AF to perform AI/ML processing.

In an embodiment, the UE configuration information includes at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;
protection policy information of the core network assistance information.

Here, the UE configuration information may be associated with the core network assistance information exposed to AF, and/or the UE configuration information may be associated with the core network assistance information not exposed to AF.

In a possible implementation, the identity information of AF is associated with AF being authorized to access the core network assistance information, or the identity information of AF is associated with AF not being authorized to access the core network assistance information.

In a possible implementation, the identity information of AF may include at least one of the following: identity information of an authorized AF; identity information of an unauthorized AF.

In a possible implementation, the identity information of AF is used to indicate at least one of the following: AF_ID, application layer identifier (ID), and a fully qualified domain name (FQDN).

In a possible implementation, the service identity information is associated with a service that is authorized to access the core network assistance information and/or a service that is not authorized to access the core network assistance information.

In a possible implementation, the identity information of UE is used to indicate at least one of the following: a subscription permanent identifier (SUPI), a subscription concealed identifier (SUCI), an IP multimedia private identity (IMPI), an application layer ID of UE, and a generic public subscription identifier (GPSI).

In a possible implementation, the group identity information of UE includes but is not limited to at least one of the following: external group identifier; group identifier; personal IoT network ID (PIN ID); external PIN ID, internal PIN ID.

In a possible implementation, AI/ML operational information is used to indicate at least one of the following: model training, model segmentation, and inference feedback.

In a possible implementation, the authorization policy information of the core network assistance information is used to indicate at least one of the following: an AF that can access and/or modify the preset core network assistance information.

The data type of the core network assistance information may be divided based on one of the following: service, data attribute. For example, the data type includes: location information, time information.

Exemplarily, the data type and detailed content of the core network assistance information are shown in Table 1 (the core network assistance information here can be 5G core network assistance information).

In a possible implementation, the protection policy information is at least used to indicate a protection manner used for the core network assistance information during transmission. The protection manner includes but is not limited to at least one of the following: anonymization and differential privacy.

Exemplarily, taking the first entity as UDM as an example, if UE has generated or updated the UE configuration information, UE carries the UE configuration information in the N1 NAS message and sends it to AMF.

AMF calls Nudm_ParameterProvision_Update service operation to UDM, where the service operation carries the UE configuration information. UDM stores the UE configuration information by calling Nudr_DM_Update (SUPI, subscription data) service operation accordingly.

AMF responds to UE through the UE configuration information setting response in the N1 NAS message, determines that the operation is successful, and the like.

In this way, the permission to expose the core network assistance information to AF can be set through the access configuration information, the privacy of the core network assistance information is protected, and the security of the core network assistance information is improved.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

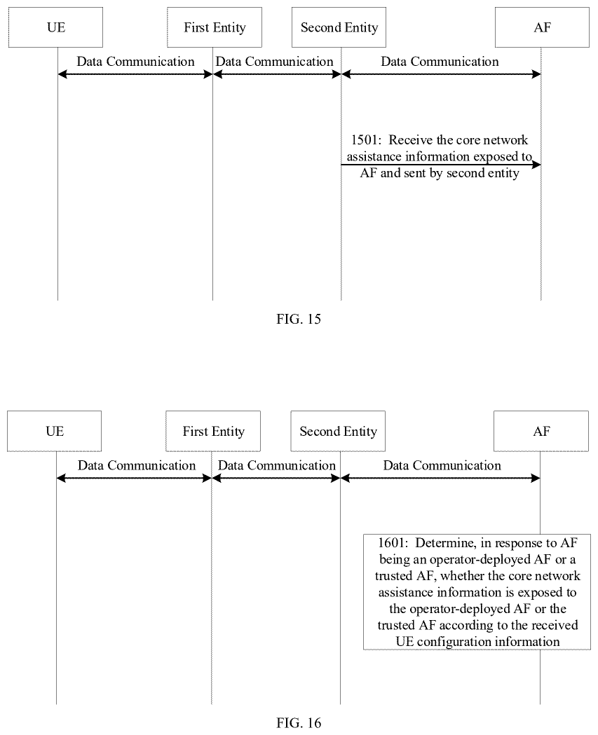

As shown in FIG. 15, some exemplary embodiments provide an information transmission method, which may be performed by an application function AF and includes followings.

In step 1501, core network assistance information exposed to AF and sent by the second entity is received.

AF may request core network assistance information from the second entity by sending an assistance information request to the second entity, and the second entity may determine the core network assistance information exposed to AF based on the UE configuration information, and send to AF the core network assistance information exposed to AF.

In a possible implementation, the assistance information request may request core network assistance information.

In a possible implementation, the assistance information request includes but is not limited to at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;

The assistance information request requests specific content of the core network assistance information, and its specific expression is similar to the core network assistance information, which will not be repeated here.

In a possible implementation, the second entity may query UE assistance information according to at least one item in the assistance information request, and determine the authorization policy of the core network assistance information for AF.

In a possible implementation, the second entity may query UE assistance information according to at least one item in the assistance information request, so as to determine the protection policy of the core network assistance information with respect to AF.

After receiving the assistance information request from AF, the second entity may determine the access authority of AF based on the access configuration information, determine the core network assistance information exposed to AF, and send to AF the core network assistance information exposed to AF.

In an embodiment, the assistance information request includes at least one of the following:
identity information of UE; and
UE group identifier associated with UE.

When referring to that the UE configuration information is associated with the identity information of UE, it may mean that the UE configuration information is UE configuration information of UE identified by the identity information of UE.

A network entity, such as a second entity, and the like, may determine the UE configuration information of UE based on the identity information of UE.

The identity information of UE associated with a UE group identifier may include identity information corresponding to UE belonging to a UE group identified by the UE group identifier.

The second entity may determine the corresponding UE configuration information based on the identity information of UE in the UE group, and further determine the core network assistance information exposed to AF.

In an embodiment, the core network assistance information expose to AF and sent by the second entity is sent in a security protection manner, where the security protection manner is indicated by the access configuration information.

As shown in FIG. 16, some exemplary embodiments provide an information transmission method, which may be performed by an application function AF and includes followings.

In step 1601, in response to AF being an operator-deployed AF or a trusted AF, it is determined whether the core network assistance information is exposed to the operator-deployed AF or the trusted AF according to the received UE configuration information.

In a possible implementation, the operator-deployed AF or the trusted AF also serves as the first entity, so the operator-deployed AF or the trusted AF obtains the UE configuration information from UE. Therefore, the operator-deployed AF or the trusted AF can directly determine whether the core network assistance information is exposed to the operator-deployed AF or the trusted AF based on the obtained UE configuration information.

The operator-deployed AF or the trusted AF can determine the core network assistance information of the associated UE based on the AI/ML services it performs, and determine the corresponding UE configuration information based on the identity information of UE, and then determine whether the core network assistance information is exposed to the operator-deployed AF or the trusted AF.

In an embodiment, sending the assistance information request to the second entity includes:
in response to determining that the core network assistance information is exposed to the operator-deployed AF or the trusted AF, sending the assistance information request to the second entity.

When it is determined that the core network assistance information is exposed to the operator-deployed AF or the trusted AF, an assistance information request is sent. The probability of failing to obtain the core network assistance information can be reduced, and the communication efficiency can be improved.

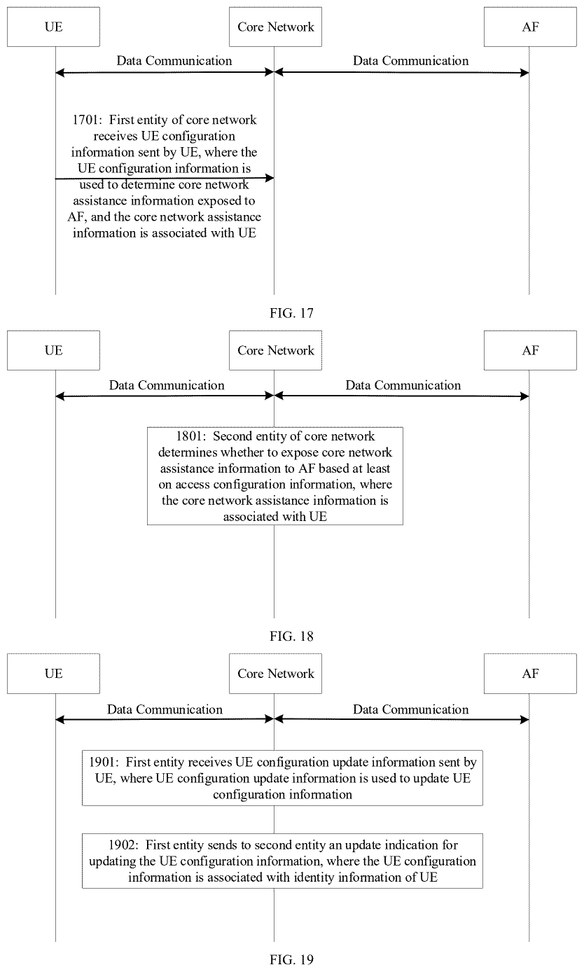

As shown in FIG. 17, some exemplary embodiments provide an information transmission method, which may be performed by a core network and includes followings.

In step 1701, a first entity of the core network receives UE configuration information sent by UE, where the UE configuration information is used to determine core network assistance information exposed to AF, and the core network assistance information is associated with UE.

The first entity may be a network entity for storing and distributing core network assistance information. UE may send the UE configuration information to the first entity. When AF is to access the core network assistance information, authorization confirmation may be performed based on the UE configuration information stored in the first entity, that is, it is determined whether AF can access the core network assistance information.

The second entity may be a network entity for sending core network assistance information to AF. The second entity may obtain UE configuration information from the first entity and determine the core network assistance information exposed to AF.

AF may request the core network assistance information from the second entity by means of a request or the like. The second entity may determine the core network assistance information exposed to AF based on the UE configuration information, and send to AF the core network assistance information exposed to AF.

AF can perform subsequent processing, such as AI/ML processing, based on the acquired core network assistance information.

AF can be an application server.

In a possible implementation, UE sends the UE configuration information to the first entity through an access network device.

In a possible implementation, UE sends the UE configuration information to the first entity through an access network device and a core network element (e.g., AMF).

The core network assistance information exposed to the application function AF may be the core network assistance information that AF is authorized to access. The core network assistance information that AF is authorized to access may include: the core network assistance information that AF is authorized to request and/or the core network assistance information that AF is authorized to modify.

In an embodiment, the first entity includes at least one of the following:
unified data management (UDM);
unified data repository function (UDR);
an operator-deployed AF or a trusted AF.

Here, the operator-deployed AF or the trusted AF is different from other AFs. The operator-deployed AF or the trusted AF is an AF trusted by the core network and has the authority to store and distribute the core network assistance information.

In a possible implementation, the UE configuration information is also used to determine the core network assistance information exposed to the operator-deployed AF or the trusted AF.

In a possible implementation, the UE configuration information may be used to indicate the core network assistance information exposed to AF.

In a possible implementation, the UE configuration information may be used to indicate core network assistance information that is not exposed to AF.

In an embodiment, the UE configuration information includes user consent information, where the user consent information is used to indicate that the user of UE agrees to expose the core network assistance information to the application function AF.

The core network assistance information may be information used by AF to perform AI/ML processing.

In an embodiment, the UE configuration information includes at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;
protection policy information of the core network assistance information.

Here, the UE configuration information may be associated with the core network assistance information exposed to AF, and/or the UE configuration information may be associated with the core network assistance information not exposed to AF.

In a possible implementation, the identity information of AF is associated with AF being authorized to access the core network assistance information, or the identity information of AF is associated with AF not being authorized to access the core network assistance information.

In a possible implementation, the identity information of AF may include at least one of the following: identity information of an authorized AF; identity information of an unauthorized AF.

In a possible implementation, the identity information of AF is used to indicate at least one of the following: AF_ID, application layer identifier (ID), and a fully qualified domain name (FQDN).

In a possible implementation, the service identity information is associated with a service that is authorized to access the core network assistance information and/or a service that is not authorized to access the core network assistance information.

In a possible implementation, the identity information of UE is used to indicate at least one of the following: a subscription permanent identifier (SUPI), a subscription concealed identifier (SUCI), an IP multimedia private identity (IMPI), an application layer ID of UE, and a generic public subscription identifier (GPSI).

In a possible implementation, the group identity information of UE includes but is not limited to at least one of the following: external group identifier; group identifier; personal IoT network ID (PIN ID); external PIN ID, internal PIN ID.

In a possible implementation, AI/ML operational information is used to indicate at least one of the following: model training, model segmentation, and inference feedback.

In a possible implementation, the authorization policy information of the core network assistance information is used to indicate at least one of the following: an AF that can access and/or modify the preset core network assistance information.

The data type of the core network assistance information may be divided based on one of the following: service, data attribute. For example, the data type includes: location information, time information.

Exemplarily, the data type and detailed content of the core network assistance information are shown in Table 1 (the core network assistance information here can be 5G core network assistance information).

In a possible implementation, the protection policy information is at least used to indicate a protection manner used for the core network assistance information during transmission. The protection manner includes but is not limited to at least one of the following: anonymization and differential privacy.

Exemplarily, taking the first entity as UDM as an example, if UE has generated or updated the UE configuration information, UE carries the UE configuration information in the N1 NAS message and sends it to AMF.

AMF calls Nudm_ParameterProvision_Update service operation to UDM, where the service operation carries the UE configuration information. UDM stores the UE configuration information by calling Nudr_DM_Update (SUPI, subscription data) service operation accordingly.

AMF responds to UE through the UE configuration information setting response in the N1 NAS message, determines that the operation is successful, and the like.

In this way, the permission to expose the core network assistance information to AF can be set through the UE configuration information, the privacy of the core network assistance information is protected, and the security of the core network assistance information is improved.

As shown in FIG. 18, some exemplary embodiments provide an information transmission method, which may be performed by a core network and includes followings.

In step 1801, a second entity of the core network determines whether to expose core network assistance information to AF based at least on access configuration information, where the core network assistance information is associated with UE.

The access configuration information may be pre-stored in the second entity, or may be sent to the second entity by other entities, such as the first entity.

The first entity may be a network entity for storing and distributing core network assistance information. UE may send the UE configuration information to the first entity. When AF is to access the core network assistance information, authorization confirmation may be performed based on the UE configuration information stored in the first entity, that is, it is determined whether AF can access the core network assistance information.

The second entity may be a network entity for sending core network assistance information to AF. The second entity may obtain UE configuration information from the first entity and determine the core network assistance information exposed to AF.

AF may request the core network assistance information from the second entity by means of a request or the like. The second entity may determine the core network assistance information exposed to AF based on the UE configuration information, and send to AF the core network assistance information exposed to AF.

AF can perform subsequent processing, such as AI/ML processing, based on the acquired core network assistance information.

In a possible implementation, the access configuration information includes at least one item of: UE configuration information; and a local policy pre-stored in the second entity.

In an embodiment, the access configuration information includes: the UE configuration information and/or a local policy pre-stored in the second entity, where the UE configuration information is sent by the first entity to the second entity, and the UE configuration information is subscribed or requested by the second entity to the first entity.

In a possible implementation, UE sends the UE configuration information to the first entity through an access network device.

In a possible implementation, UE sends the UE configuration information to the first entity through an access network device and a core network element (e.g., AMF).

The core network assistance information exposed to the application function AF may be the core network assistance information that AF is authorized to access. The core network assistance information that AF is authorized to access may include: the core network assistance information that AF is authorized to request and/or the core network assistance information that AF is authorized to modify.

In an embodiment, the access configuration information includes: a local policy pre-stored in the second entity.

The local policy pre-stored in the second entity and the UE configuration information may indicate the core network assistance information exposed to AF, and/or indicate the core network assistance information not exposed to AF.

In response to the local policy pre-stored in the second entity and the UE configuration information having different indications for the same core network assistance information, the priority of the local policy pre-stored in the second entity and the UE configuration information may be pre-defined, with the indication of the higher priority prevailing.

As shown in FIG. 19, some exemplary embodiments provide an information transmission method, which may be performed by a core network and includes followings.

In step 1901, a first entity receives UE configuration update information sent by UE, where the UE configuration update information is used to update the UE configuration information;

In step 1902, the first entity sends an update indication to the second entity for updating the UE configuration information, where the UE configuration information is associated with identity information of UE.

UE may determine the UE configuration information and update the UE configuration information. UE may update the UE configuration information through the UE configuration update information.

The updating of the UE configuration information includes but is not limited to one of the following: modifying the content in the UE configuration information; deleting the content in the UE configuration information; adding content in the UE configuration information.

In a possible implementation, the UE configuration update information may be sent to the first entity in the same manner as the UE configuration information.

Exemplarily, taking the first entity as UDM as an example, if UE has updated the UE configuration information, UE carries the UE configuration update information in the N1 NAS message and sends it to AMF.

AMF calls the Nudm_ParameterProvision_Update service operation to UDM, where the service operation carries the UE configuration update information. UDM updates the stored UE configuration information by calling the Nudr_DM_Update (SUPI, Subscription Data) service operation accordingly. AMF responds to UE with the UE configuration information set response in the N1 NAS message, thereby confirming that the operation is successful, and the like.

UE may determine the UE configuration information and update the UE configuration information. UE may update the UE configuration information through the UE configuration update information.

The updating of the UE configuration information includes but is not limited to one of the following: modifying the content in the UE configuration information; deleting the content in the UE configuration information; adding content in the UE configuration information.

In a possible implementation, the UE configuration update information may be sent to the first entity in the same manner as the UE configuration information.

Exemplarily, taking the first entity as UDM as an example, if UE has updated the UE configuration information, UE carries the UE configuration update information in the N1 NAS message and sends it to AMF.

AMF calls the Nudm_ParameterProvision_Update service operation to UDM, where the service operation carries the UE configuration update information. UDM updates the stored UE configuration information by calling the Nudr_DM_Update (SUPI, Subscription Data) service operation accordingly. AMF responds to UE with the UE configuration information set response in the N1 NAS message, thereby confirming that the operation is successful, and the like.

In an embodiment, the UE configuration update information is used to prohibit the core network assistance information from being exposed to AF.

In a possible implementation, the UE configuration update information may prohibit the core network assistance information from being exposed to AF by updating the UE configuration information.

In a possible implementation, the UE configuration update information may directly indicate that the core network assistance information is prohibited from being exposed to AF.

In an embodiment, the UE configuration update information is used to prohibit the core network assistance information from being exposed to AF.

In a possible implementation, the UE configuration update information may prohibit the core network assistance information from being exposed to AF by updating the UE configuration information.

In a possible implementation, the UE configuration update information may directly indicate that the core network assistance information is prohibited from being exposed to AF.

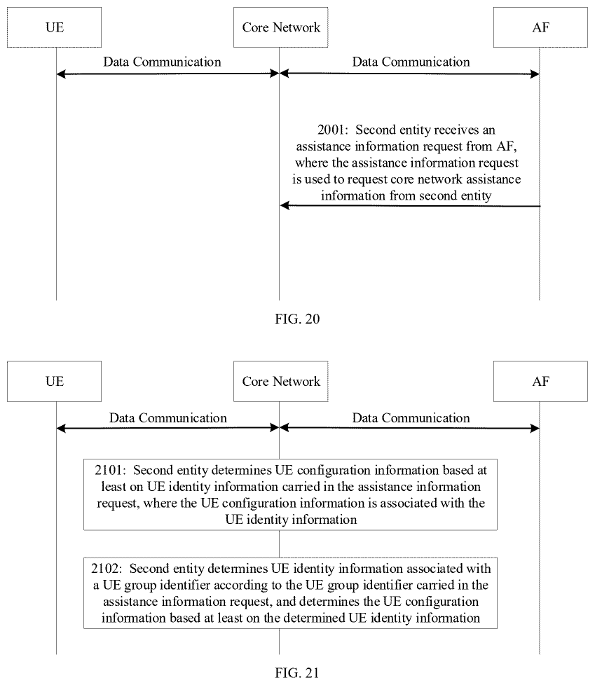

As shown in FIG. 20, some exemplary embodiments provide an information transmission method, which may be performed by a core network and includes followings.

In step 2001, a second entity receives an assistance information request from AF, where the assistance information request is used to request the core network assistance information from the second entity.

AF may request core network assistance information from the second entity by sending an assistance information request to the second entity, and the second entity may determine the core network assistance information exposed to AF based on the UE configuration information, and send to AF the core network assistance information exposed to AF.

In a possible implementation, the assistance information request may request core network assistance information.

In a possible implementation, the assistance information request includes but is not limited to at least one of the following:
identity information of AF;
service identity information;
a data type of the core network assistance information;
details of the core network assistance information;
identity information of UE;
group identity information of UE;
AI/ML operational information;
validity period of authorization policy information of the core network assistance information;
the authorization policy information of the core network assistance information;
The assistance information request requests specific content of the core network assistance information, and its specific expression is similar to the core network assistance information, which will not be repeated here.

In a possible implementation, the second entity may query UE assistance information according to at least one item in the assistance information request, and determine the authorization policy of the core network assistance information for AF.

In a possible implementation, the second entity may query UE assistance information according to at least one item in the assistance information request, so as to determine the protection policy of the core network assistance information with respect to AF. After receiving the assistance information request from AF, the second entity may determine the access authority of AF based on the access configuration information, determine the core network assistance information exposed to AF, and send to AF the core network assistance information exposed to AF.

As shown in FIG. 21, some exemplary embodiments provide an information transmission method, which may be performed by a core network and includes at least one of the following.

In step 2101, the second entity determines the UE configuration information based at least on identity information of UE carried in the assistance information request, where the UE configuration information is associated with the identity information of UE.

In step 2102, the second entity determines the identity information of UE associated with a UE group identifier according to the UE group identifier carried in the assistance information request, and determines the UE configuration information based at least on the determined identity information of UE.

When referring to that the UE configuration information is associated with the identity information of UE, it may mean that the UE configuration information is UE configuration information of UE identified by the identity information of UE.

A network entity, such as a second entity, and the like, may determine the UE configuration information of UE based on the identity information of UE.

The identity information of UE associated with a UE group identifier may include identity information corresponding to UE belonging to a UE group identified by the UE group identifier.

The second entity may determine the corresponding UE configuration information based on the identity information of UE in the UE group, and further determine the core network assistance information exposed to AF.

As shown in FIG. 22, some exemplary embodiments provide an information transmission method, which may be performed by a core network and includes at least one of the following.

In step 2201, the second entity sends to AF the core network assistance information exposed to AF.

After determining the core network assistance information to be exposed to AF based on the access configuration information, the second entity can send the core network assistance information to AF.

Since the core network assistance information sent to AF is authorized through the access configuration information, privacy of the core network assistance information is protected, thereby improving the security of the core network assistance information.

In an embodiment, sending, by the second entity to AF, the core network assistance information that allows AF to access includes:
sending, by the second entity to AF, the core network assistance information exposed to AF in a security protection manner, where the security protection manner is indicated by the access configuration information.

In a possible implementation, the security protection manner includes at least one of the following: differential privacy, and anonymization.

A specific example is provided below in combination with any of the above embodiments.

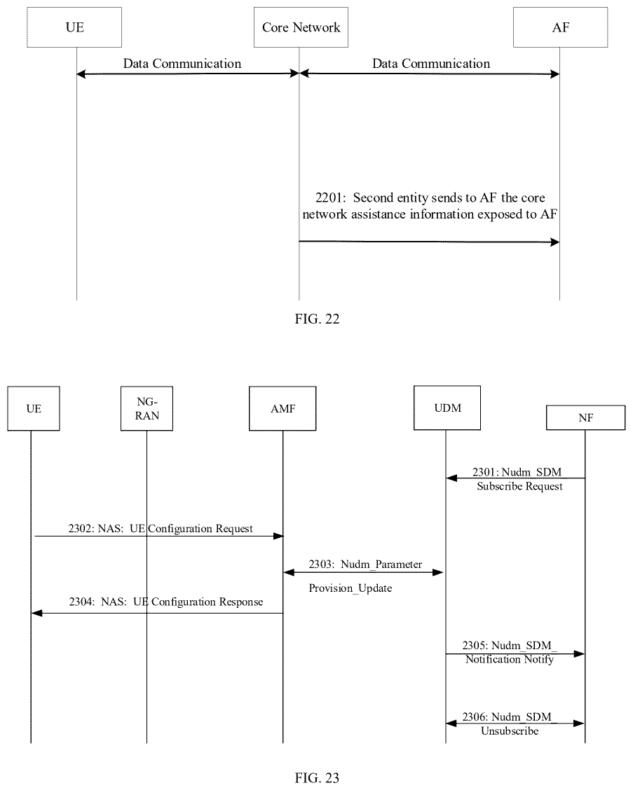

In Example I, as shown in FIG. 23, steps for setting a UE configuration file (UE profile) specifically include the followings.

In step 2301, the second entity, such as NF (e.g., CAPIF core function, CAPIF authorization function, CAPIF API exposure function, NEF, NWDAF) can subscribe to UDM notification of updating the UE profile through instructions such as Nudm_SDM_Subscribe Request.

In step 2302, if UE has generated or updated the UE profile, UE sends the latest updated part of UE profile to AMF via UE Profile Setup in the N1 NAS message.

In step 2303, AMF calls Nudm_ParameterProvision_Update service operation to the first entity, such as UDM, where the service operation carries the updated part of UE profile. UDM stores or updates UE profile in UDR by calling Nudr_DM_Update (SUPI, subscription data) service operation accordingly.

In step 2304, AMF responds to UE with a UE Profile Setup Response in the N1 NAS message.

In step 2305, UDM notifies the subscribed second entity of the updated UE profile through Nudm_SDM_Notification Notify message.

In step 2306, NF (e.g., CAPIF core function, CAPIF authorization function, API exposure function, NEF, NWDAF) can unsubscribe from the UDM notification of UE profile, for example, by unsubscribing through the Nudm_SDM_Unsubscribe instruction.

### Example II

The UE profile is stored in UDM/UDR. For each target UE, UE profile determines whether a specific AF can request or modify specific information of a specific UE. The UE profile includes AF identity (e.g. AF_ID, application layer ID, FQDN), expected service identifier, data type of target 5GC assistance information (e.g. location information), details of target 5GC assistance information (e.g. TAI), target UE identity (e.g. SUPI, SUCI, IMPI, UE application layer ID, GPSI), AI/ML operations (e.g., model training, segmentation and inference feedback, etc.), expiration time (invalidation), authorization policy (e.g. specific AF can access/modify specific 5GC assistance information). Here, the 5GC assistance information is core network assistance information.

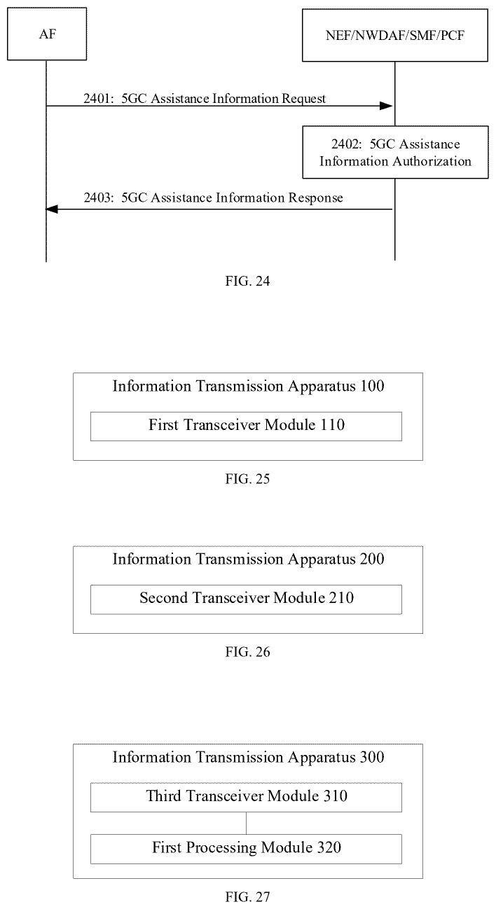

In Example III, as shown in FIG. 24, an authorization process of the UE configuration information (UE profile) specifically includes the following steps.

In step 2401, AF sends a core network assistance information request, i.e., a 5GC assistance information request, to a second entity, such as NEF/NWDAF. The request includes AF identity (e.g., AF_ID, application layer ID, FQDN), expected service identifier, data type of target 5GC assistance information (e.g., location information), details of target 5GC assistance information (e.g., TAI), target UE identity (e.g., IMPI, UE application layer ID, GPSI), and AI/ML operations (e.g., model training, segmentation, and inference feedback, etc.).

In step 2402, after receiving the request, NEF/NWDAF identifies UE profile according to the identity of the target UE. If NEF/NWDAF does not have the UE profile, NEF/NWDAF obtains the profile according to the steps shown in FIG. 23.
a) NEF/NWDAF determines, based on the UE profile, whether UE authorizes AF to access the 5GC assistance information.
b) NEF/NWDAF determines, based on a local policy, whether AF is authorized to access the 5GC assistance information.

In step 2403, when the local policy and UE profile authorize AF to access the information, NEF/NWDAF sends the 5GC assistance information to AF. According to the local policy and UE profile, NEF/NWDAF is to protect the 5GC assistance information by using a security mechanism (e.g., differential privacy, anonymization). The 5GC assistance information is core network assistance information.

As shown in FIG. 25, some exemplary embodiments provide an information transmission apparatus 100, which is provided in user equipment UE and includes:
a first transceiver module 110, configured to send UE configuration information to a first entity, wherein the UE configuration information is used to determine core network assistance information exposed to an application function AF, and the core network assistance information is associated with the UE.

In an embodiment, the first transceiver module 110 is further configured to: send UE configuration update information to the first entity, where the UE configuration update information is used to update the UE configuration information.

In an embodiment, the UE configuration update information is used to prohibit the core network assistance information from being exposed to the AF.

In an embodiment, the UE configuration information is associated with identity information of the UE; and the UE configuration information is to be sent to a second entity by the first entity.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

As shown in FIG. 26, some exemplary embodiments provide an information transmission apparatus 200, which is provided in a first entity and includes:
a second transceiver module 210, configured to receive UE configuration information sent by user equipment UE, wherein the UE configuration information is used to determine core network assistance information exposed to an application function AF, and the core network assistance information is associated with the UE.

In an embodiment, the second transceiver module 210 is further configured to: receive UE configuration update information sent by the UE, where the UE configuration update information is used to update the UE configuration information.

In an embodiment, the UE configuration update information is used to prohibit the core network assistance information from being exposed to the AF.

In an embodiment, the second transceiver module 210 is further configured to: send to a second entity an update indication to update the UE configuration information, where the UE configuration information is associated with identity information of the UE.

In an embodiment, the second transceiver module 210 is further configured to: send the UE configuration information to a second entity, where the UE configuration information is subscribed or requested by the second entity to the first entity.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

As shown in FIG. 27, some exemplary embodiments provide an information transmission apparatus 300, which is provided in a second entity and includes:
a first processing module 320, configured to determine, based at least on access configuration information, whether to expose core network assistance information to an application function AF, wherein the core network assistance information is associated with user equipment UE.

In an embodiment, the apparatus further includes:
a third transceiver module 310, configured to: receive an assistance information request from the AF, where the assistance information request is used to request the core network assistance information from the second entity.

In an embodiment, the first processing module 320 is further configured to implement at least one of following:
determining UE configuration information based at least on identity information of the UE carried in the assistance information request, where the UE configuration information is associated with the identity information of the UE;
determining, according to a UE group identifier carried in the assistance information request, identity information of the UE associated with the UE group identifier, and determining UE configuration information based at least on the determined identity information of the UE.

In an embodiment, the access configuration information includes: UE configuration information and/or a local policy pre-stored in the second entity; and
the apparatus further includes: a third transceiver module 310, configured to receive the UE configuration information sent by the first entity.

In an embodiment, the first entity includes at least one of following:
unified data management UDM;
unified data repository function UDR;
an operator-deployed AF or a trusted AF.

In an embodiment, the apparatus further includes: a third transceiver module, configured to:
send to the AF the core network assistance information exposed to the AF.

In an embodiment, the third transceiver module 310 is specifically configured to: send to the AF the core network assistance information exposed to the AF in a security protection manner, where the security protection manner is indicated by the access configuration information.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes user consent information, and the user consent information is used to indicate that a user of the UE agrees to expose the core network assistance information to the AF.

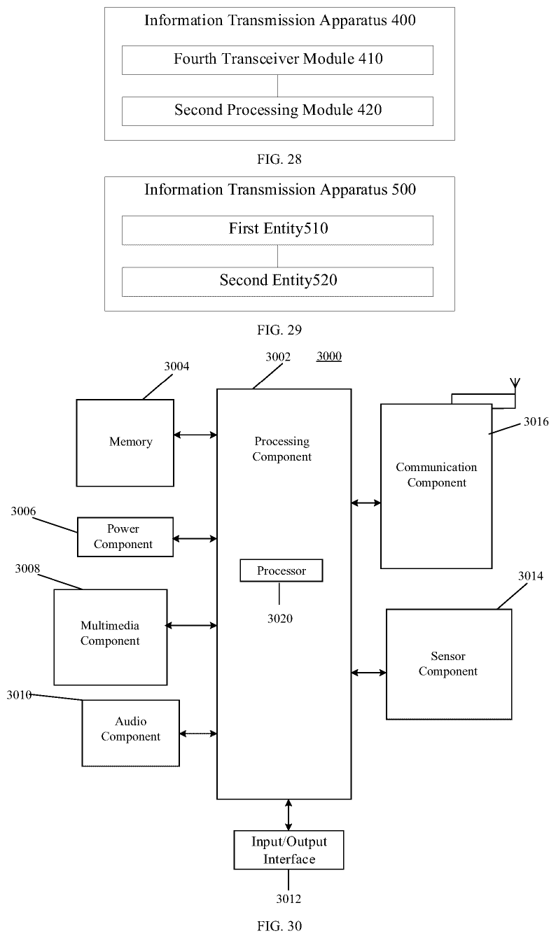

As shown in FIG. 28, some exemplary embodiments provide an information transmission apparatus 400, which is provided in the application function AF, and includes: a fourth transceiver module 410, configured to send an assistance information request to a second entity, wherein the assistance information request is used to request the second entity to expose core network assistance information to the AF, the core network assistance information exposed to the AF is determined by the second entity based at least on access configuration information, and the core network assistance information is associated with user equipment UE.

In an embodiment, the access configuration information includes at least one of following:
UE configuration information;
a local policy pre-stored in the second entity.

In an embodiment, the assistance information request includes at least one of following:
identity information of the UE;
a UE group identifier associated with the UE.

In an embodiment, the fourth transceiver module 410 is further configured to: receive the core network assistance information exposed to the AF and sent by the second entity.

In an embodiment, the core network assistance information exposed to the AF and sent by the second entity is sent in a security protection manner, and the security protection manner is indicated by the access configuration information.

In an embodiment, the apparatus further includes:
a second processing module 420, configured to: in response to the AF being an operator-deployed AF or a trusted AF, determine, according to received UE configuration information, whether the core network assistance information is exposed to the operator-deployed AF or the trusted AF;
the fourth transceiver module 410 is specifically configured to:
send, in response to determining that the core network assistance information is exposed to the operator-deployed AF or the trusted AF, the assistance information request to the second entity.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes user consent information, and the user consent information is used to indicate that a user of the UE agrees to expose the core network assistance information to the AF.

As shown in FIG. 29, some exemplary embodiments provide an information transmission apparatus 500, which is provided in a core network and includes:

a first entity 510 of the core network, configured to receive UE configuration information sent by user equipment UE, where the UE configuration information is used to determine core network assistance information exposed to an application function AF, and the core network assistance information is associated with the UE.

In an embodiment, a second entity 520 of the core network determines, based at least on access configuration information, whether to expose the core network assistance information to the AF, where the core network assistance information is associated with the UE.

In an embodiment, the access configuration information includes: UE configuration information and/or a local policy pre-stored in the second entity, where the UE configuration information is sent by the first entity to the second entity, and the UE configuration information is subscribed or requested by the second entity to the first entity.

In an embodiment,
the first entity receives UE configuration update information sent by the UE, where the UE configuration update information is used to update the UE configuration information; and
the first entity sends to the second entity an update indication to update the UE configuration information, where the UE configuration information is associated with identity information of the UE.

In an embodiment, the UE configuration update information is used to prohibit the core network assistance information from being exposed to the AF.

In an embodiment, the second entity receives an assistance information request of the AF, where the assistance information request is used to request the core network assistance information from the second entity.

In an embodiment, the second entity determines, based at least on identity information of the UE carried in the assistance information request, the UE configuration information, where the UE configuration information is associated with the identity information of the UE;
and/or
the second entity determines, according to a UE group identifier carried in the assistance information request, identity information of the UE associated with the UE group identifier, and determines the UE configuration information based at least on the determined identity information of the UE.

In an embodiment, the second entity sends to the AF the core network assistance information exposed to the AF.

In an embodiment, sending, by the second entity to the AF, the core network assistance information that allows the AF to access includes:
sending, by the second entity to the AF, the core network assistance information exposed to the AF in a security protection manner, where the security protection manner is indicated by the access configuration information.

In an embodiment, the second entity includes at least one of following:
core function of common application interface framework CAPIF;
authorization function of CAPIF;
application programming interface API exposure function;
network exposure function NEF;
network data analysis function NWDAF;
policy control function PCF;
session management function SMF.

In an embodiment, the UE configuration information includes at least one of following:
identity information of the AF;
service identity information;
a data type of the core network assistance information;
details of the core network assistance information;
identity information of the UE;
group identity information of the UE;
AI/ML operational information;
validity period of authorization policy information of the core network assistance information;
the authorization policy information of the core network assistance information;
protection policy information of the core network assistance information.

In an embodiment, the first entity includes at least one of following:
unified data management UDM;
unified data repository function UDR;
an operator-deployed AF or a trusted AF.

In an embodiment, the UE configuration information includes user consent information, and the user consent information is used to indicate that a user of the UE agrees to expose the core network assistance information to the AF.

Embodiments of the present disclosure provide a communication device, including:
a processor; and
a memory, configured to store executable instructions of the processor;
where, the processor is configured to, upon running the executable instructions, implement the information transmission method according to any embodiment of the present disclosure.

In some embodiments, the communication device may include but is not limited to at least one of: UE and network device. Here, the network device may include core network or access network device, etc. Here, the access network device may include a base station; the core network may include AMF and SMF.

The processor may include various types of storage medium, which are non-transitory computer storage medium that can continue to memorize information stored thereon after the user device loses power.

The processor may be connected to the memory via a bus or the like, and may be used to read an executable program stored in the memory, for example, at least one of the methods shown in FIG. 2 to FIG. 23.

Embodiments of the present disclosure also provide a computer storage medium storing a computer executable program, which, when the executable program is executed by a processor, implements the information transmission method according to any embodiment of the present disclosure, for example, at least one of the methods shown in FIG. 2 to FIG. 23.

Regarding the apparatus or storage medium in the above embodiments, the specific manner in which each module performs operations has been described in detail in the embodiments of the method, and will not be elaborated here.

FIG. 30 is a schematic diagram of UE 3000 according to an exemplary embodiment. For example, UE 3000 may be a mobile phone, a computer, a digital broadcast terminal, a messaging device, a game console, a tablet device, a medical device, a fitness device, a personal digital assistant, etc.

As shown in FIG. 30, UE 3000 may include one or more of the following components: a processing component 3002, a memory 3004, a power component 3006, a multimedia component 3008, an audio component 3010, an input/output (I/O) interface 3012, a sensor assembly 3014, and a communication component 3016.

The processing component 3002 generally controls the overall operation of UE 3000, such as operations associated with display, phone calls, data communications, camera operations, and recording operations. The processing component 3002 may include one or more processors 3020 to execute instructions to complete all or part of the steps of the above-mentioned methods. In addition, the processing component 3002 may include one or more modules to facilitate the interaction between the processing component 3002 and other components. For example, the processing component 3002 may include a multimedia module to facilitate the interaction between the multimedia component 3008 and the processing component 3002.

The memory 3004 is configured to store various types of data to support operations on UE 3000. Examples of such data include instructions for any application or method operating on UE 3000, contact data, phone book data, messages, pictures, videos, etc. The memory 3004 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 3006 provides power to the various components of the UE 3000. The power component 3006 may include a power management system, one or more power supplies, and other components associated with generating, managing, and distributing power for the UE 3000.

The multimedia component 3008 includes a screen that provides an output interface between the UE 3000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 3008 includes a front camera and/or a rear camera. When the UE 3000 is in an operating mode, such as a shooting mode or a video mode, the front camera and/or the rear camera may receive external multimedia data. Each front camera and the rear camera may be a fixed optical lens system or have a focal length and optical zoom capability.

The audio component 3010 is configured to output and/or input audio signals. For example, the audio component 3010 includes a microphone (MIC), and when the UE 3000 is in an operating mode, such as a call mode, a recording mode, and a speech recognition mode, the microphone is configured to receive an external audio signal. The received audio signal can be further stored in the memory 3004 or sent via the communication component 3016. In some embodiments, the audio component 3010 also includes a speaker for outputting audio signals.

I/O interface 812 provides an interface between processing component 3002 and peripheral interface modules, such as keyboards, click wheels, buttons, etc. These buttons may include, but are not limited to, a home button, a volume button, a start button, and a lock button.

The sensor assembly 3014 includes one or more sensors for providing various aspects of status assessment for the UE 3000. For example, the sensor assembly 3014 can detect the open/closed state of the UE 3000, the relative positioning of components, such as the display and keypad of the UE 3000, and the sensor assembly 3014 can also detect the position change of the UE 3000 or a component of the UE 3000, the presence or absence of user contact with the UE 3000, the orientation or acceleration/deceleration of the UE 3000, and the temperature change of the UE 3000. The sensor assembly 3014 may include a proximity sensor configured to detect the presence of nearby objects without any physical contact. The sensor assembly 3014 may also include an optical sensor, such as a CMOS or CCD image sensor, for use in imaging applications. In some embodiments, the sensor assembly 3014 may also include an acceleration sensor, a gyroscope sensor, a magnetic sensor, a pressure sensor, or a temperature sensor.

The communication component 3016 is configured to facilitate wired or wireless communication between the UE 3000 and other devices. The UE 3000 can access a wireless network based on a communication standard, such as WiFi, 4G or 5G, or a combination thereof. In an exemplary embodiment, the communication component 3016 receives a broadcast signal or broadcast-related information from an external broadcast management system via a broadcast channel. In an exemplary embodiment, the communication component 3016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the UE 3000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an exemplary embodiment, a non-transitory computer-readable storage medium including instructions is also provided, such as a memory 3004 including instructions, which can be executed by a processor 3020 of the UE 3000 to perform the above methods. For example, the non-transitory computer-readable storage medium can be a ROM, a random access memory (RAM), a CD-ROM, a magnetic tape, a floppy disk, an optical data storage device, etc.

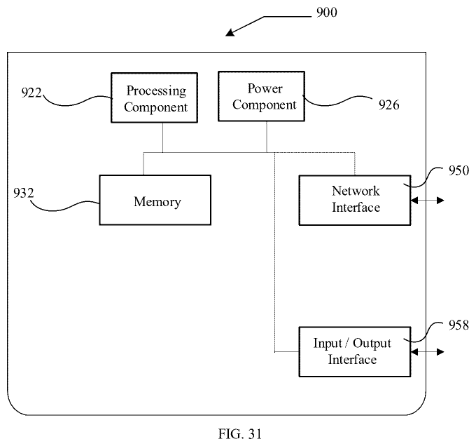

As shown in FIG. 31, an embodiment of the present disclosure shows a structure of a base station. For example, the base station 900 may be provided as a network-side device. Referring to FIG. 31, the base station 900 includes a processing component 922, which further includes one or more processors, and a memory resource represented by a memory 932 for storing instructions executable by the processing component 922, such as an application. The application stored in the memory 932 may include one or more modules, each corresponding to a set of instructions. In addition, the processing component 922 is configured to execute instructions to execute any method of the aforementioned method applied to the base station.

The base station 900 may also include a power supply component 926 configured to perform power management of the base station 900, a wired or wireless network interface 950 configured to connect the base station 900 to the network, and an input/output (I/O) interface 958. The base station 900 may operate based on an operating system stored in the memory 932, such as Windows Server™, Mac OS X™, Unix™, Linux™, FreeBSD™ or the like.

Those skilled in the art will readily appreciate other embodiments of the present invention after considering the specification and practicing the invention disclosed herein. The present disclosure is intended to cover any variations, uses or adaptations of the present invention that follow the general principles of the present invention and include common knowledge or customary techniques in the art that are not disclosed in the present disclosure. The description and examples are to be considered exemplary only, and the true scope and spirit of the present invention are indicated by the following claims.

It should be understood that the present invention is not limited to the exact construction that has been described above and shown in the drawings and that various modifications and changes may be made without departing from the scope thereof. The scope of the present invention is limited only by the appended claims.

1. A method for data transmission, performed by a user equipment (UE), the method comprising:
sending UE configuration information to a first entity, wherein the UE configuration information is used to determine core network assistance information exposed to an application function AF, and the core network assistance information is associated with the UE.

2. The method according to claim 1, further comprising:
sending UE configuration update information to the first entity, wherein the UE configuration update information is used to update the UE configuration information.

3. The method according to claim 2, wherein the UE configuration update information is used to prohibit the core network assistance information from being exposed to an application function (AF).

4. The method according to claim 1, wherein the UE configuration information is associated with identity information of the UE; and the UE configuration information is to be sent to a second entity by the first entity.

5. The method according to claim 4, wherein the second entity comprises at least one of:
core function of common application interface framework (CAPIF);
authorization function of the CAPIF;
application programming interface (API) exposure function;
network exposure function (NEF);
network data analysis function (NWDAF);
policy control function (PCF); or
session management function (SMF).

6. The method according to claim 1, wherein the UE configuration information comprises at least one of:
identity information of an application function (AF);
service identity information;
a data type of the core network assistance information;
details of the core network assistance information;
identity information of the UE;
group identity information of the UE;
artificial intelligence (AI)/machine learning (ML) operational information;
validity period of authorization policy information of the core network assistance information;
the authorization policy information of the core network assistance information; or
protection policy information of the core network assistance information.

7. The method according to claim 1, wherein the first entity comprises at least one of:
unified data management (UDM);
unified data repository function (UDR); or
an operator-deployed application function (AF) or a trusted AF.

8. The method according to claim 1, wherein the UE configuration information comprises user consent information, and the user consent information is used to indicate that a user of the UE agrees to expose the core network assistance information to an application function (AF).

9. A method for data transmission, performed by a first entity, the method comprising:
receiving user equipment (UE) configuration information sent by user equipment UE, wherein the UE configuration information is used to determine core network assistance information exposed to an application function (AF), and the core network assistance information is associated with the UE.

10. The method according to claim 9, further comprising:
receiving UE configuration update information sent by the UE, wherein the UE configuration update information is used to update the UE configuration information.

11. (canceled)

12. The method according to claim 10, further comprising: sending to a second entity an update indication to update the UE configuration information, wherein the UE configuration information is associated with identity information of the UE.

13. The method according to claim 9, further comprising: sending the UE configuration information to a second entity, wherein the UE configuration information is subscribed or requested by the second entity to the first entity.

14.-17. (canceled)

18. A method for data transmission performed by a second entity, the method comprising:
determining, based at least on access configuration information, whether to expose core network assistance information to an application function (AF), wherein the core network assistance information is associated with user equipment (UE).

19. The method according to claim 18, further comprising:
receiving an assistance information request from the AF, wherein the assistance information request is used to request the core network assistance information from the second entity.

20. The method according to claim 19, further comprising at least one of:
determining UE configuration information based at least on identity information of the UE carried in the assistance information request, wherein the UE configuration information is associated with the identity information of the UE;
determining, according to a UE group identifier carried in the assistance information request, identity information of the UE associated with the UE group identifier, or
determining the UE configuration information based at least on the identity information of the UE determined.

21. The method according to claim 18, wherein
the access configuration information comprises: UE configuration information and/or a local policy pre-stored in the second entity; and
the method further comprises: receiving the UE configuration information sent by a first entity.

22. (canceled)

23. The method according to claim 18, further comprising:
sending to the AF the core network assistance information exposed to the AF.

24.-55. (canceled)

56. A communication device comprising:
a processor; and
a memory, configured to store executable instructions of the processor;
wherein the executable instructions, when executed by the processor, cause the communication device to act as the UE and perform the method according to claim 1.

57. A communication device comprising:
a processor; and
a memory, configured to store executable instructions of the processor;
wherein, the executable instructions, when executed by the processor cause the communication device to act as the first entity and perform the method according to claim 9.

58. A communication device comprising:
a processor; and
a memory, configured to store executable instructions of the processor;
wherein, the executable instructions, when executed by the processor cause the communication device to act as the second entity and perform the method according to claim 9.
